(19) United States
(12) Patent Application Publication
(10) Pub. No.: US 2026/0126664 A1
(43) Pub. Date: May 7, 2026

(54) HEAD-WEARABLE ELECTRONIC DEVICE INCLUDING SUPPORTING MEMBER

(71) Applicant: Samsung Electronics Co., Ltd., Suwon-si (KR)

(72) Inventors: Kyoungsun LEE, Suwon-si (KR); Hoeun YOO, Suwon-si (KR); Jiseong HWANG, Suwon-si (KR)

(21) Appl. No.: 19/341,815

(22) Filed: Sep. 26, 2025

Related U.S. Application Data
(63) Continuation of application No. PCT/KR2025/014486, filed on Sep. 17, 2025.

(30) Foreign Application Priority Data
Nov. 5, 2024 (KR) 10-2024-0155320
Dec. 13, 2024 (KR) 10-2024-0185601

(51) Int. Cl. G02B 27/01

(52) U.S. Cl. CPC G02B 27/0176; G02B 2027/0154; G02B 2027/0169

(57) ABSTRACT

A head-wearable electronic device includes an enclosure. The enclosure includes at least one display disposed in front of eyes of a user when the head-wearable electronic device is worn. The enclosure includes a frame supporting the at least one display. The head-wearable electronic device includes a rear cover supported by a head of the user and a side band connecting the enclosure to the rear cover. The side band includes a housing including a portion connected to an inner portion of the frame, and a supporting member. The portion of the housing of the side band defines a groove. The supporting member includes a base portion contacting the portion of the housing of the side band and the frame of the enclosure, and a protrusion disposed at the groove.

### CROSS-REFERENCE TO RELATED APPLICATIONS

This application is a continuation of International Application No. PCT/KR2025/014486 designating the United States, filed on Sep. 17, 2025, in the Korean Intellectual Property Receiving Office and claiming priority to Korean Patent Application Nos. 10-2024-0155320, filed on Nov. 5, 2024, and 10-2024-0185601, filed on Dec. 13, 2024, in the Korean Intellectual Property Office, the disclosures of each of which are incorporated by reference herein in their entireties.

### BACKGROUND

### Field

The disclosure relates to a head-wearable electronic device including a supporting member.

### Description of Related Art

To provide an enhanced user experience, an electronic device providing an extended reality service that displays information generated by a computer in connection with an external object in a real world or a virtual object in a virtual world is being developed. The electronic device may include a wearable device that may be worn by a user. For example, the wearable device may be worn on a head of the user. The wearable device (or the electronic device) worn on the head of the user may be referred to as a head-wearable electronic device. For example, the electronic device may include user equipment, AR glasses, VR glasses, and/or a head-mounted device (HMD) (e.g., a video see through (VST) HMD or an optical see through (OST) HMD).

The above-described information may be provided as related art for the purpose of helping the understanding of the present disclosure. No assertion or determination is made as to whether any of the above-described content may be applied as prior art associated with the present disclosure.

### SUMMARY

According to an example embodiment, a head-wearable electronic device may comprise: an enclosure. The enclosure may include at least one display disposed in front of eyes of a user when the head-wearable electronic device is worn. The enclosure may include a frame supporting the at least one display. The head-wearable electronic device may comprise a rear cover supported by a head of the user wearing the head-wearable electronic device. The head-wearable electronic device may comprise a side band connecting the enclosure to the rear cover. The side band may include a housing defining an exterior of the side band and including a portion connected to an inner portion of the frame. The side band may include a supporting member. The portion of the housing of the side band may define a groove. The supporting member may include a base portion contacting with the frame of the enclosure and the portion of the housing of the side band. The supporting member may include a protrusion portion, extending from the base portion of the side band to the groove, disposed at the groove.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIGS. 1A, 1B and 1C are diagrams including perspective views of an example head-wearable electronic device according to various embodiments;

FIG. 2 is an exploded perspective view of an example head-wearable electronic device according to various embodiments;

FIGS. 3A and 3B are diagrams including perspective views of an example side band of a head-wearable electronic device according to various embodiments;

FIG. 4A is a diagram illustrating an example of a connection structure between an enclosure and a side band of a head-wearable electronic device according to various embodiments;

FIG. 4B includes a diagram and perspective view illustrating an example of a force transmitted to a connection structure between an enclosure and a side band by an external force applied to a head-wearable electronic device according to various embodiments;

FIG. 4C is a diagram illustrating examples of deformation caused in a connection structure between an enclosure and a side band by an external force applied to a head-wearable electronic device according to various embodiments;

FIG. 5A includes perspective views of an example of a connection structure between an enclosure and a side band of a head-wearable electronic device including a supporting member according to various embodiments;

FIG. 5B is a diagram illustrating an example of a connection state of a connection structure including a supporting member according to various embodiments;

FIGS. 6A and 6B are perspective views of an example supporting member according to various embodiments;

FIG. 7A is a perspective view illustrating an example of a force transmitted to a connection structure between an enclosure and a side band including a supporting member by an external force applied to a head-wearable electronic device according to various embodiments;

FIG. 7B includes diagrams illustrating examples of deformation caused in a connection structure between an enclosure and a side band by an external force applied to a head-wearable electronic device according to various embodiments;

FIG. 8 is a diagram illustrating an example supporting member including a hole for a screw according to various embodiments;

FIG. 9A includes perspective views illustrating an example of a fixing structure between a first housing part and a second housing part of a side band according to various embodiments;

FIG. 9B is a diagram illustrating an example of a connection state of a fixing structure between a first housing part and a second housing part of a side band according to various embodiments;

FIG. 10A includes perspective views illustrating an example of a fixing structure between a first housing part of the side band and a frame of an enclosure according to various embodiments;

FIG. 10B is a perspective view illustrating an example of a connection state of a fixing structure between a first housing part of a side band and a frame of an enclosure according to various embodiments;

FIG. 11 is a diagram illustrating examples of a supporting member according to various embodiments; and

FIG. 12 is a block diagram illustrating an example electronic device in a network environment according to various embodiments.

### DETAILED DESCRIPTION

Terms used in the present disclosure are used simply to describe various example embodiments, and are not intended to limit the scope of the disclosure to a specific embodiment. A singular expression may include a plural expression unless the context clearly indicates otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B).

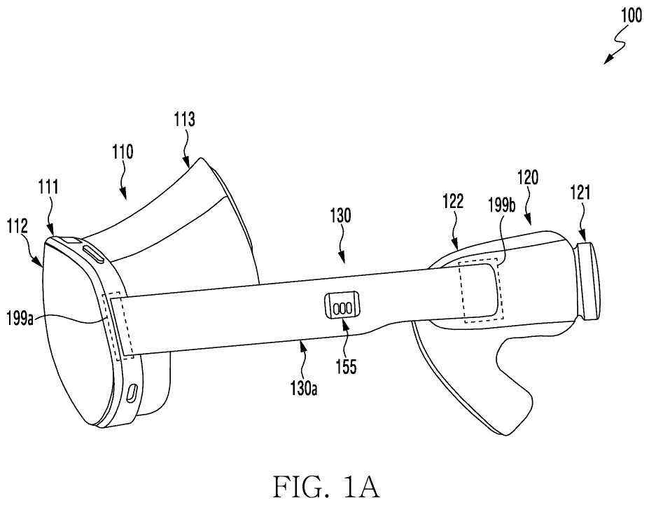

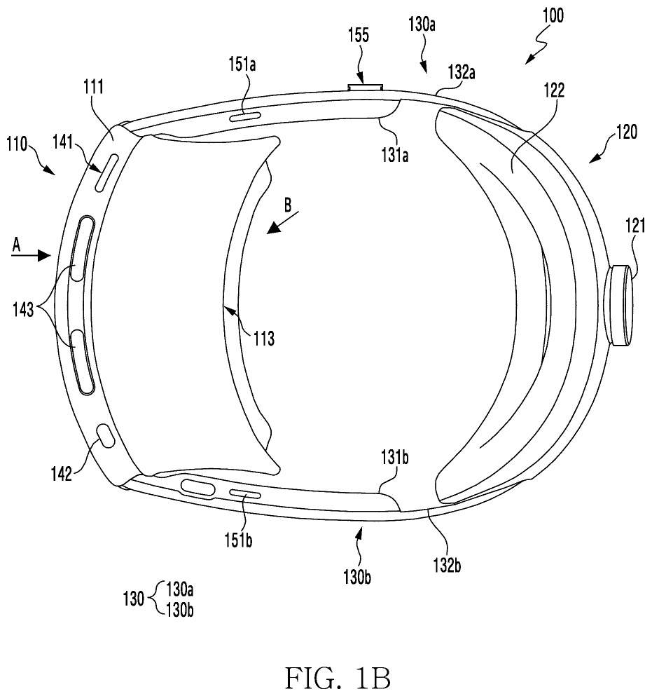

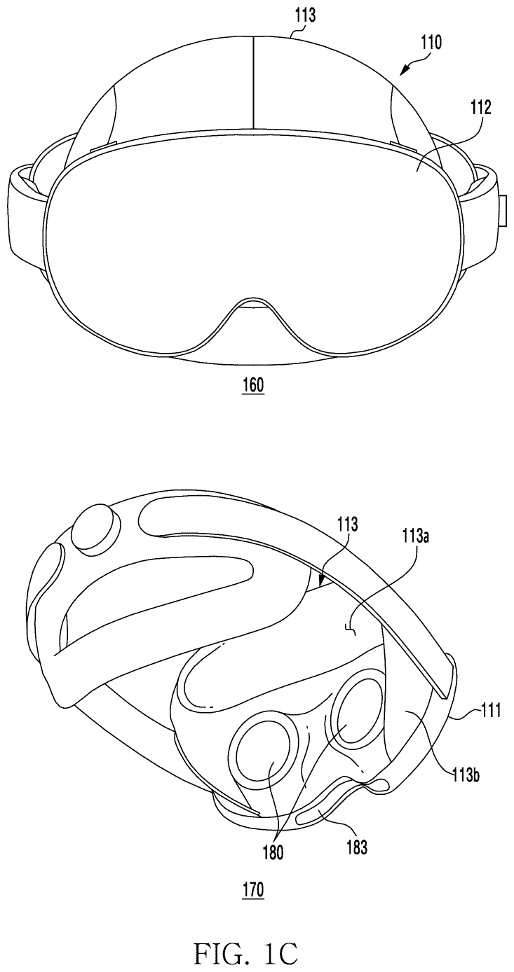

FIGS. 1A, 1B and 1C are diagrams including perspective views of an example head-wearable electronic device according to various embodiments.

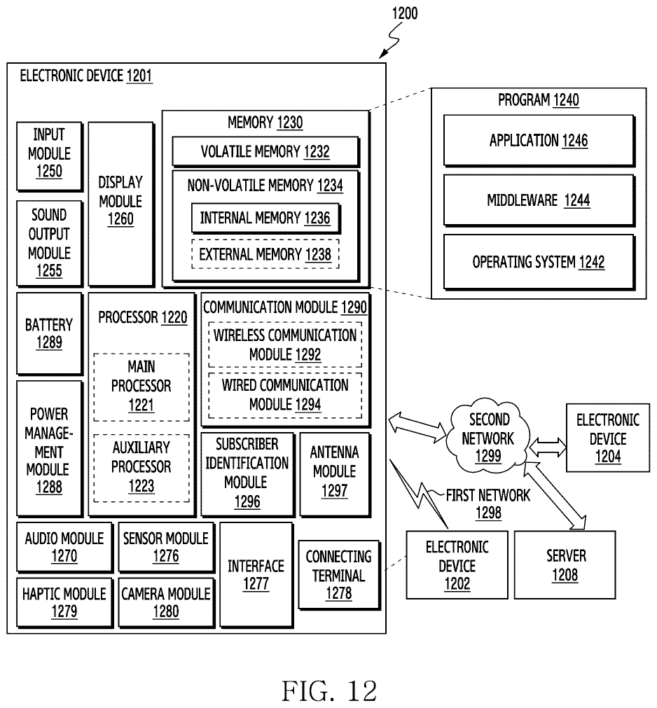

FIG. 1A illustrates an example of a perspective view of a head-wearable electronic device 100 in a case in which the head-wearable electronic device 100 is viewed from a lateral surface. For example, the head-wearable electronic device 100 may be worn on a body part of a user. For example, the body part may include a head of the user. As a non-limiting example, the head-wearable electronic device 100 may have a form of glasses that are wearable on the head of the user. For example, the head-wearable electronic device 100 may be an example of an electronic device 1201 of FIG. 12. The head-wearable electronic device 100 may include at least a portion of components of the electronic device 1201 of FIG. 12.

For example, the head-wearable electronic device 100 may provide augmented reality (AR), virtual reality (VR), or mixed reality (MR) in which augmented reality and virtual reality are mixed, to a user wearing the head-wearable electronic device 100. For example, an image (or a visual object, a visual effect, a virtual object) indicating augmented reality, virtual reality, or mixed reality may be displayed through at least one display (e.g., at least one display 180 of FIG. 1C) of the head-wearable electronic device 100.

Referring to FIG. 1A, the head-wearable electronic device 100 may include an enclosure 110, a rear cover 120, and a side band 130. For example, the enclosure 110 may be referred to as a main body, a main housing, or a front housing. For example, the rear cover 120 may be referred to as a back band, a rear band, or a rear housing. For example, the side band 130 may be referred to as a temple or a lateral housing.

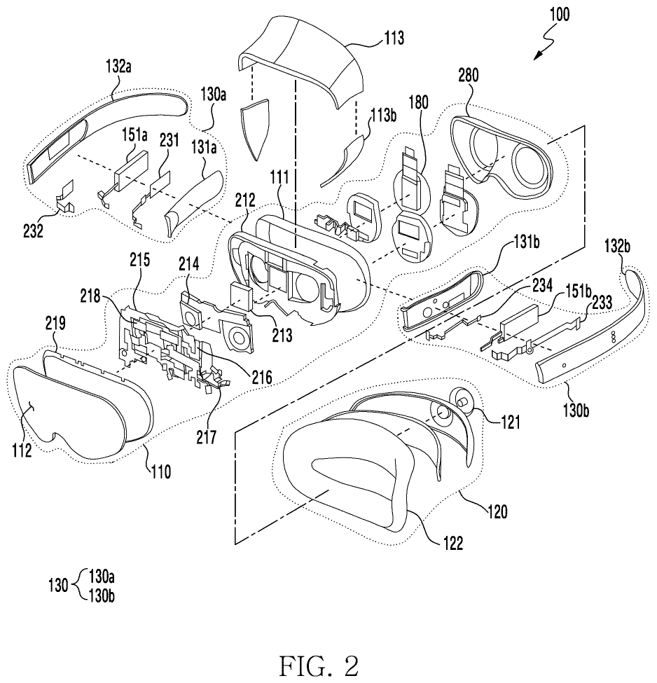

For example, the enclosure 110 may be a component of the head-wearable electronic device 100 that includes components (or electronic components) for providing augmented reality, virtual reality, or mixed reality to the user wearing head-wearable electronic device 100. At least some of components included in an inner space of the enclosure 110 are illustrated and described with reference to FIG. 2. In an example of FIG. 1A, the enclosure 110 may include a frame 111, a glass 112, and a front cover 113.

For example, the frame 111 may define an exterior of the enclosure 110. As a non-limiting example, the frame 111 may be formed of a metal material. The frame 111 may be referred to as a metal body. For example, the space inside the exterior of the enclosure 110 defined by the frame 111 may include electronic components.

For example, the glass 112 may be disposed on a front surface of the enclosure 110. For example, the glass 112 may be coupled with at least a portion of the frame 111 of the enclosure 110. For example, the glass 112 may be referred to as a visor or a front visor. As a non-limiting example, at least a portion of the glass 112 may be formed of a substantially transparent or substantially translucent material so that a camera (e.g., a camera module 1280 of FIG. 12) of the head-wearable electronic device 100 may receive light from the outside of the head-wearable electronic device 100.

For example, the front cover 113 may be disposed on a rear surface of the enclosure 110. For example, the front cover 113 may be coupled with at least another portion of the frame 111 of the enclosure 110. For example, the front cover 113 may be referred to as a brow pad cover. For example, at least a portion of the front cover 113 may be contacted with (or supported by) a body part (e.g., forehead) of the user when the head-wearable electronic device 100 is worn by the user.

For example, the rear cover 120 may be contacted with (or supported by) a body part (e.g., occipital) of the user when the head-wearable electronic device 100 is worn by the user. In an example of FIG. 1A, the rear cover 120 may include an adjustment structure 121 for adjusting a size (or a circumference) of the head-wearable electronic device 100 to fit a size (or a circumference) of the head of the user, and a rear pad 122 that is contacted with a body part (e.g., occipital) of the user.

For example, the adjustment structure 121 may be used to adjust a length of the side band 130 that is visible (or visually exposed) from the outside of the head-wearable electronic device 100. As a non-limiting example, the length of the side band 130 may increase as the adjustment structure 121 is rotated in a first direction (e.g., clockwise). In addition, the length of the side band 130 may decrease as the adjustment structure 121 is rotated in a direction (e.g., counterclockwise) opposite to the first direction. In the above example, the adjustment structure 121 that adjusts the length of the side band 130 according to rotation is described, but the present disclosure is not limited thereto.

For example, the rear pad 122 may be contacted with a body part (e.g., occipital) of the user. For example, the rear pad 122 may be referred to as a rear cushion. As a non-limiting example, the rear pad 122 may move relatively according to adjustment by the adjustment structure 121. For example, the rear pad 122 may become closer to or farther from the front cover 113 according to adjustment by the adjustment structure 121.

For example, the side band 130 may connect the enclosure 110 to the rear cover 120. For example, the side band 130 may be disposed between the enclosure 110 and the rear cover 120. For example, the side band 130 may be coupled with (or contacted with or connected to) the enclosure 110 in a region 199a. For example, the side band 130 may be coupled with (or contacted with or connected to) the rear cover 120 in a region 199b. In an example of FIG. 1A, the side band 130 may include a housing 130a and an interface 155 for charging the head-wearable electronic device 100. In an example of FIG. 1A, a perspective view of the head-wearable electronic device 100 viewed from the lateral surface is illustrated, and the side band 130 including the one housing 130a is illustrated, but the present disclosure is not limited thereto. For example, the side band 130 may include a plurality of housings (e.g., the housing 130a and the housing 130b of FIG. 1B). In addition, for example, the side band 130 may be formed as one housing configured to pass through the rear cover 120.

For example, the housing 130a may define an exterior of the side band 130. As a non-limiting example, the housing 130a may include a plurality of housing parts. An example of the housing 130a including the plurality of housing parts may be referenced in FIG. 1B. For example, the housing 130a may be referred to as a first housing of the side band 130.

The interface 155 may be disposed on a surface of the housing 130a. For example, the interface 155 may be disposed on the surface of the housing 130a that is visible from the outside of the head-wearable electronic device 100. For example, the interface 155 may be referred to as a charging port or a charging connector. For example, power may be provided to the head-wearable electronic device 100 from the outside through a wired interface connected to the interface 155.

FIG. 1B is a perspective view of the head-wearable electronic device 100 in a case of viewing the head-wearable electronic device 100 from above according to various embodiments. Referring to FIG. 1B, the head-wearable electronic device 100 may include the enclosure 110, the rear cover 120, and the side band 130.

Referring to FIG. 1B, on a surface of the frame 111 of the enclosure 110, a button 141 for adjusting volume of speakers 151a and 151b, a button 142 for turning power of the head-wearable electronic device 100 on/off, and a ventilation structure 143 may be disposed. In an example of FIG. 1B, the button 141, the button 142, and the ventilation structure 143 are illustrated as being disposed on the surface (or an upper end surface) facing an upper end of the frame 111, but the present disclosure is not limited thereto. For example, a component that is at least partially different from the button 141, the button 142, and the ventilation structure 143 illustrated in FIG. 1B may be disposed on the surface of the frame 111.

For example, the button 141 may be used to adjust volume of sound outputted through the speakers 151a and 151b or other speakers. For example, the other speakers may not be illustrated in FIG. 1B. For example, the button 142 may be used to turn the power of the head-wearable electronic device 100 on/off. For example, turning the power on may include providing power from a battery (e.g., a battery 213 of FIG. 2) of the head-wearable electronic device 100 to the electronic components in the head-wearable electronic device 100. For example, turning the power off may include refraining from (or stopping or ceasing) providing power from the battery (e.g., the battery 213 of FIG. 2) of the head-wearable electronic device 100 to the electronic components in the head-wearable electronic device 100. For example, the ventilation structure 143 may be configured to allow air to move between an inner portion of the enclosure 110 (or an inner portion of the frame 111 of the enclosure 110) and the outside of the head-wearable electronic device 100 (or the outside of the enclosure 110). As a non-limiting example, the ventilation structure 143 may include an opening.

For example, the glass 112 of FIG. 1B may be disposed on the front surface of the enclosure 110 (or the frame 111) so as to be visible when the head-wearable electronic device 100 is viewed from an A direction. In addition, for example, at least one display (e.g., the at least one display 180 of FIG. 1C) may be disposed on the rear surface of the enclosure 110 (or the frame 111) so as to be visible when the head-wearable electronic device 100 is viewed from a B direction. An example related to this may be referenced in FIG. 1C.

FIG. 1C includes a perspective view 160 of a head-wearable electronic device 100 viewed from the A direction of FIG. 1B and a perspective view 170 of the head-wearable electronic device 100 viewed from the B direction of FIG. 1B.

Referring to the example 160, the enclosure 110 of the head-wearable electronic device 100 may include the glass 112 disposed to face the front surface and the front cover 113 disposed to face the rear surface.

Referring to the example 170, the front cover 113 may include a front pad 113a that is contacted with a body part (e.g., forehead) of the user when the head-wearable electronic device 100 is worn by the user. For example, the front pad 113a may be referred to as a cushion. For example, the front cover 113 may include a lateral cover 113b for blocking light that may enter from a lateral surface.

Referring to the example 170, the enclosure 110 may include the at least one display 180. In the example 170, the at least one display 180 including two displays is illustrated, but the present disclosure is not limited thereto. For example, the at least one display 180 may include an integrated display. For example, the at least one display 180 may be disposed in front of eyes of the user when the head-wearable electronic device 100 is worn by the user. For example, the frame 111 of the enclosure 110 may support the at least one display 180. For example, the ventilation structure 183 may be disposed on a surface (e.g., a lower end surface) of the frame 111. For example, the ventilation structure 183 may be configured to allow air to move between the inner portion of the enclosure 110 (or the inner portion of the frame 111 of the enclosure 110) and the outside of the head-wearable electronic device 100 (or the outside of the enclosure 110). As a non-limiting example, the ventilation structure 183 may include an opening.

Referring back to FIG. 1B, the adjustment structure 121 of the rear cover 120 may be disposed at a center portion of the rear cover 120. However, the present disclosure is not limited thereto. For example, the adjustment structure 121 may be disposed at a portion (e.g., a lateral portion of the rear cover 120) different from the center portion of the rear cover 120. For example, the adjustment structure 121 may be disposed on a surface opposite to a surface on which the rear pad 122 is disposed.

For example, the side band 130 may include the housing 130a and the housing 130b. For example, the housing 130b may be referred to as a second housing. However, the present disclosure is not limited thereto. For example, the housing 130a and the housing 130b may be implemented as integrated housing. For example, the housing 130a may include a first housing part 131a and a second housing part 132a. For example, the first housing part 131a may be configured to be contacted with the head of the user wearing the head-wearable electronic device 100. For example, the second housing part 132a may be disposed opposite to the first housing part 131a. For example, the second housing part 132a may be visible from the outside of the head-wearable electronic device 100 when the head-wearable electronic device 100 is worn by the user. Similar to the above example, the housing 130b may include a first housing part 131b and a second housing part 132b.

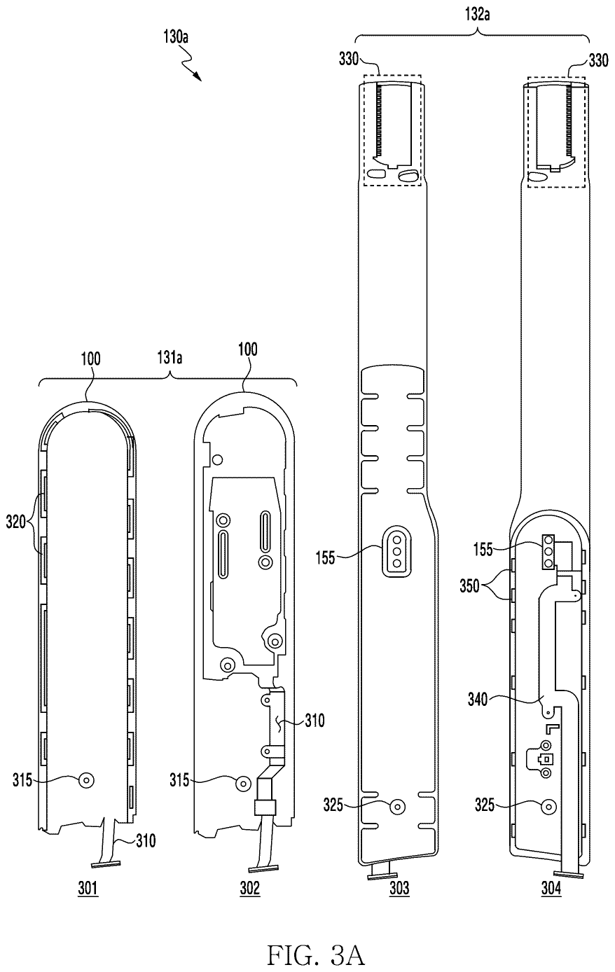

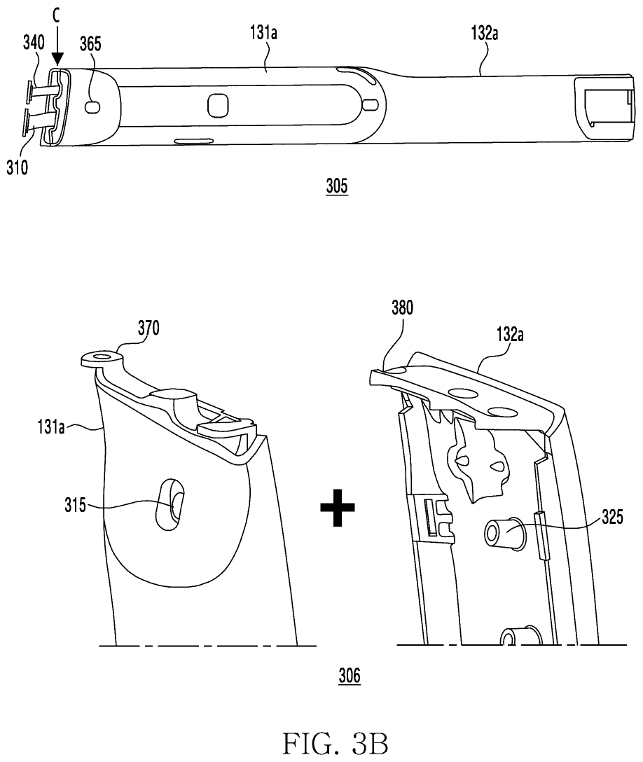

For example, the first housing part 131a of the housing 130a may include a first speaker 151a. For example, the first housing part 131b of the housing 130b may include a second speaker 151b. As a non-limiting example, the first housing part 131a of the housing 130a may include the interface 155. An example of a structure of the housing 130a and the housing 130b may be referenced in FIG. 3A.

FIG. 2 is an exploded perspective view of an example head-wearable electronic device according to various embodiments.

FIG. 2 illustrates an example of an exploded perspective view of a head-wearable electronic device 100 of FIGS. 1A, 1B and 1C (which may be referred to as FIGS. 1A to 1C). FIG. 2 illustrates examples of components included in each of an enclosure 110, a rear cover 120, and a side band 130 of the head-wearable electronic device 100.

Referring to FIG. 2, the enclosure 110 may include a glass 112, a front bracket 219, a PCB 215, a main bracket 212, a frame 111, at least one display 180, and a lens bracket 280. For example, the glass 112 may be disposed on a front surface of the front bracket 219. For example, the printed circuit board (PCB) 215 may be disposed between the frame 111 (or the main bracket 212) and the glass 112 (or the front bracket 219). For example, the main bracket 212 may be disposed within a space defined by the frame 111. For example, the at least one display 180 may be disposed between the frame 111 (or the main bracket 212) and the lens bracket 280.

For example, the main bracket 212 may be disposed in the space defined by the frame 111 and may include openings for disposing components. For example, a battery 213 may be disposed on a surface (e.g., a surface facing the glass 112 or a surface facing the front bracket 219) of the main bracket 212. For example, the battery 213 may store power to be provided to electronic components of the head-wearable electronic device 100. For example, at least one fan 214 may be included on the surface (e.g., the surface facing the glass 112 or the surface facing the front bracket 219) of the main bracket 212. For example, the at least one fan 214 may be used to cool heat that may be generated by electronic components in the enclosure 110 (or the frame 111). As a non-limiting example, a vapor chamber may be further included in a region adjacent to a region in which the at least one fan 214 is positioned. For example, the vapor chamber may be a structure for conducting heat.

For example, the PCB 215 may be disposed on the surface (e.g., the surface facing the glass 112 or the surface facing the front bracket 219) of the main bracket 212. In addition, for example, the PCB 215 may be disposed on a surface (e.g., a surface facing the main bracket 212) of the front bracket 219. As a non-limiting example, the PCB 215 may include a button switch 216 connected to the button 142 of FIG. 1B, a microphone 217, and an antenna 218. For example, each of the button switch 216, the microphone 217, and the antenna 218 may be disposed on the PCB 215. For example, the button switch 216 may be connected to the button 142 of FIG. 1B. For example, an input to the button 142 may be an input to the button switch 216. For example, the microphone 217 may be an example of an input device for receiving sound from the outside. For example, the antenna 218 may be an example of a communication device for performing communication with an external electronic device (or a server) according to a communication technique (e.g., Wi-Fi, BT, or BLE).

In an example of FIG. 2, the button switch 216, the microphone 217, and the antenna 218 disposed on the PCB 215 are illustrated, but the present disclosure is not limited thereto. For example, a head tracking (HeT) module (or a head tracker) may be disposed on the PCB 215. In addition, for example, a module for video see-through (VST) may be disposed on the PCB 215. In addition, for example, a plurality of sensors may be disposed on the PCB 215. For example, the plurality of sensors may include an infrared ray (IR) sensor or a time of flight (ToF) sensor (e.g., indirect-ToF (i-ToF) or direct-ToF (d-ToF)).

For example, the glass 112 may be disposed on a surface of the front bracket 219. As a non-limiting example, the front bracket 219 may include a plurality of brackets. For example, a first bracket of the front bracket 219 may be a bracket connected to the PCB 215, and a second bracket of the front bracket 219 may be a bracket connected to the glass 112.

For example, the at least one display 180 between the frame 111 (or the main bracket 212) and the lens bracket 280 may include a lens. For example, the at least one display 180 may include a transparent or translucent lens. The at least one display 180 may include a first display and/or a second display spaced apart from the first display. For example, the first display and the second display may be disposed at positions respectively corresponding to a left eye and a right eye of a user.

The at least one display 180 may provide the user with visual information transmitted from external light through the lens included in the at least one display 180, and other visual information distinguished from the visual information. The lens may be formed based on at least one of, for example, and without limitation, a Fresnel lens, a pancake lens, a multi-channel lens, or the like. For example, the at least one display 180 may include a first surface and a second surface opposite the first surface. A display area may be formed on the second surface of the at least one display 180. When the user wears the head-wearable electronic device 100, external light may be transmitted to the user by being incident on the first surface and transmitted through the second surface. According to an embodiment, the at least one display 180 may display an augmented reality video, in which a virtual reality video provided by at least one optical device is combined with a reality screen transmitted through external light, on the display area formed on the second surface.

The at least one display 180 may include at least one waveguide that diffracts light emitted from the at least one optical device and transmits the diffracted light to the user. The at least one waveguide may be formed based on at least one of glass, plastic, or polymer. A nano-pattern may be formed on at least a portion of the outside or inside of the at least one waveguide. The nano-pattern may be formed based on a grating structure of a polygonal and/or curved shape. Light incident on an end of the at least one waveguide may be propagated to another end of the at least one waveguide by the nano-pattern. The at least one waveguide may include at least one of at least one diffractive element (e.g., a diffractive optical element (DOE), a holographic optical element (HOE)), and a reflective element (e.g., a reflective mirror). For example, the at least one waveguide may be disposed in the head-wearable electronic device 100 to guide a screen displayed by the at least one display 180 to eyes of the user. For example, the screen may be transmitted to the eyes of the user based on total internal reflection (TIR) generated in the at least one waveguide.

Although not illustrated in FIG. 2, a sensor (or a camera) for tracking the eyes of the user may be included between the frame 111 (or the main bracket 212) and the lens bracket 280. For example, the sensor (or the camera) for tracking the eyes of the user may be referred to as an eye tracking (ET) sensor (or camera). The head-wearable electronic device 100 may analyze an object included in a real video collected through a shooting camera and then combine a virtual object corresponding to an object that is a target of augmented reality provision among the analyzed objects, and display it on the at least one display 180. The virtual object may include at least one of text or an image for various information related to the object included in the real video. The head-wearable electronic device 100 may analyze the object based on a multi-camera such as a stereo camera. For the object analysis, the head-wearable electronic device 100 may perform spatial recognition (e.g., simultaneous localization and mapping (SLAM)) using the multi-camera and/or time-of-flight (ToF). The user wearing the head-wearable electronic device 100 may view a video displayed on the at least one display 180.

For example, the at least one display 180 (and the lens) may be supported by the frame 111 and may be covered from the outside of the head-wearable electronic device 100 by the lens bracket 280. The lens bracket 280 may also be referred to as a display bracket.

As a non-limiting example, a front cover 113 of the enclosure 110 may include detachable lateral covers 113b. For example, the lateral covers 113b may extend from a portion of the front cover 113 or may be coupled with (or connected to) the portion of the front cover 113.

For example, a housing 130a may include a first sensor 231, a first speaker 151a, and a connector 232 in a space defined by a first housing part 131a and a second housing part 132a. For example, the first sensor 231 may include a touch sensor. For example, the connector 232 may include a universal serial bus (USB). As a non-limiting example, the connector 232 may include the interface 155 of FIG. 1A or may be connected to the interface 155.

For example, a housing 130b may include a microphone 233, a second sensor 234, and a second speaker 151b in a space defined by the first housing part 131b and the second housing part 132b. For example, the second sensor 234 may include a proximity sensor. Although not illustrated in FIG. 2, the housing 130b may further include a connection member (e.g., a pogo pin) for connection with an external battery in the space defined by the first housing part 131b and the second housing part 132b.

For example, the housing 130a or 130b of the head-wearable electronic device 100 may include a flexible material, such as rubber and/or silicone, having a form that adheres to a portion (e.g., a portion of a face surrounding both eyes) of a head of the user. For example, the housing 130a or 130b of the head-wearable electronic device 100 may be referred to as one or more straps able to be twined around the head of the user and/or one or more temples attachable to ears of the head.

Although not illustrated in FIG. 2, the head-wearable electronic device 100 may include at least one of a gyro sensor, a gravity sensor, and/or an acceleration sensor for detecting a posture of the head-wearable electronic device 100 and/or a posture of a body part (e.g., head) of the user wearing the head-wearable electronic device 100. Each of the gravity sensor and the acceleration sensor may measure gravitational acceleration and/or acceleration based on designated three-dimensional axes (e.g., an x-axis, an y-axis, and an z-axis) that are perpendicular to each other. The gyro sensor may measure an angular velocity of each of the designated three-dimensional axes (e.g., the x-axis, the y-axis, and the z-axis). At least one of the gravity sensor, the acceleration sensor, and the gyro sensor may be referred to as an inertial measurement unit (IMU). According to an embodiment, the head-wearable electronic device 100 may identify a motion and/or a gesture of the user performed to execute or cease a specific function of the head-wearable electronic device 100 based on the IMU.

Although not illustrated in FIG. 2, the head-wearable electronic device 100 may include at least one processor (e.g., including processing circuitry) and/or memory. As a non-limiting example, the at least one processor and the memory may be disposed on the PCB 215.

The at least one processor of the head-wearable electronic device 100 may include circuitry (e.g., processing circuitry) for processing data based on one or more instructions. The circuitry for processing data may include, for example, an arithmetic and logic unit (ALU), a field programmable gate array (FPGA), a central processing unit (CPU), and/or an application processor (AP). In an embodiment, the head-wearable electronic device 100 may include one or more processors. The at least one processor may have a structure of a multi-core processor such as a dual core, a quad core, a hexa core, and/or an octa core. The multi-core processor structure of the at least one processor may include a structure (e.g., a big-little structure) based on a plurality of core circuitry, distinguished by power consumption, clock, and/or amount of calculation per unit time. In an embodiment including the at least one processor having the multi-core processor structure, operations and/or functions of the present disclosure may be performed individually or collectively by one or more cores included in the at least one processor. Thus, the processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory of the head-wearable electronic device 100 may include an electronic component for storing data and/or instructions inputted to and/or outputted from the at least one processor. The memory may include, for example, volatile memory such as random-access memory (RAM) and/or non-volatile memory such as read-only memory (ROM). The volatile memory may include, for example, at least one of dynamic RAM (DRAM), static RAM (SRAM), Cache RAM, or pseudo SRAM (PSRAM). The non-volatile memory may include, for example, at least one of programmable ROM (PROM), erasable PROM (EPROM), electrically erasable PROM (EEPROM), flash memory, a hard disk, a compact disk, or an embedded multi media card (eMMC). In an embodiment, the memory may be referred to as storage.

According to an embodiment, in the memory of the head-wearable electronic device 100, one or more instructions (or commands) indicating data to be processed, calculations and/or operations to be performed by the at least one processor of the head-wearable electronic device 100 may be stored. A set of one or more instructions may be referred to as a program, firmware, an operating system, a process, a routine, a sub-routine, and/or a software application (hereinafter, application). For example, the head-wearable electronic device 100 and/or the at least one processor may perform at least one of operations when a set of a plurality of instructions distributed in a form of an operating system, firmware, a driver, a program, and/or a software application is executed. A software application being installed in the head-wearable electronic device 100 may refer, for example, to one or more instructions provided in a form of a software application (or a package) being stored in the memory, and the one or more applications being stored in an format (e.g., a file having an extension designated by an operating system of the head-wear electronic device 100) executable by the at least one processor. As an example, an application may include a program related to a service provided to the user and/or a library.

FIGS. 3A and 3B are diagrams including perspective views of an example side band of a head-wearable electronic device according to various embodiments.

FIG. 3A illustrates examples 301 and 302 including a perspective view of a first housing part 131a and examples 303 and 304 including a perspective view of a second housing part 132a, included in the housing 130a of the side band 130 of FIGS. 1A to 1C. In FIG. 3A, for convenience of explanation, the first housing part 131a and the second housing part 132a included in the housing 130a of the side band 130 are illustrated, but the present disclosure is not limited thereto. A description of FIG. 3A may be may be applied in substantially the same way to a first housing part 131b and a second housing part 132b included in a housing 130b.

In the example 301 and the example 302, components included in the first housing part 131a are illustrated. For example, the first housing part 131a may include a flexible PCB (FPCB) 310. The first housing part 131a may define (or include) a hole 315 and hook fasteners 320. For example, the FPCB 310 of the first housing part 131a may be a region in which electronic components included in the first housing part 131a are disposed. For example, the FPCB 310 may extend from the first housing part 131a and be connected (or electrically connected) to a PCB 215 in an inner portion of an enclosure 110. For example, the hole 315 (e.g., a first hole) may be an opening for a screw that connects a space between the first housing part 131a and the second housing part 132a. For example, the hole 315 may be aligned with a hole 325 (e.g., a second hole) of the second housing part 132a described below. For example, the hole 315 and the hole 325 being aligned may include being substantially aligned so that a screw may pass through when the screw connects the first housing part 131a and the second housing part 132a through the hole 315 and the hole 325. In the example 301 and the example 302 of FIG. 3A, the first housing part 131a including the hole 315 for one screw is illustrated, but the present disclosure is not limited thereto. As a non-limiting example, the first housing part 131a may define (or include) a plurality of holes. For example, the hook fastener 320 of the first housing part 131a may be coupled with hooks 350 of the second housing part 132a described below. For example, the hook fasteners 320 may be referred to as loops. For example, as the hook fasteners 320 are coupled with the hooks 350, the first housing part 131a and the second housing part 132a may be in contact (or be coupled).

In the example 303 and the example 304, components included in the second housing part 132a are illustrated. The example 303 illustrates a perspective view in a case of viewing the second housing part 132a from a first direction, and the example 304 illustrates a perspective view in a case of viewing the second housing part 132a from a second direction opposite to the first direction. For example, the second housing part 132a may include an FPCB 340 and an adjustment band 330. The second housing part 132a may define (or include) the hole 325 and the hooks 350. For example, the FPCB 340 of the second housing part 132a may be a region in which electronic components included in the second housing part 132a are disposed. As a non-limiting example, the FPCB 340 may be connected (or electrically connected) to an interface 155. For example, the FPCB 340 may extend from the second housing part 132a and be connected (or electrically connected) to the PCB 215 of the inner portion the enclosure 110. For example, the hole 325 may be an opening for the screw that connects a space between the first housing part 131a and the second housing part 132a. For example, the hole 325 may be aligned with the hole 315 of the first housing part 131a. In the example 303 and the example 304 of FIG. 3A, the second housing part 132a including the hole 325 for one screw is illustrated, but the present disclosure is not limited thereto. As a non-limiting example, the second housing part 132a may define (or include) a plurality of holes. For example, the hooks 350 of the second housing part 132a may be coupled with the hook fasteners 320 of the first housing part 131a. For example, the adjustment band 330 of the second housing part 132a may be connected to an adjustment structure 121 of a rear cover 120. The adjustment band 330 may move relatively according to an adjustment of the adjustment structure 121 of FIG. 1A. For example, the adjustment band 330 may move inside the rear cover 120 or outside the rear cover 120 according to the adjustment of the adjustment structure 121. As the adjustment band 330 moves, a length of the side band 130 (or a size (or a circumference) of the head-wearable electronic device 100) may be adjusted.

FIG. 3B illustrates an example 305 including a perspective view of the housing 130a in which the first housing part 131a and the second housing part 132a of FIG. 3A are coupled. FIG. 3B illustrates an example 306 of a perspective view of the housing 130a viewed from a C direction of the example 305 when the first housing part 131a and the second housing part 132a are spaced apart (or before the first housing part 131a and the second housing part 132a are coupled).

Referring to the example 305, the first housing part 131a and the second housing part 132a may be coupled through the screw that passes through the hole 315 and the hole 325. For example, the first housing part 131a may include a cover 365 that covers the hole 315, the hole 325, and the screw. For example, the hole 315, the hole 325, and the screw may be positioned beneath the cover 365. For example, the cover 365 may be referred to as a window, a cover housing, or a screw cover. In the example 305, an example of the first housing part 131a and the second housing part 132a being coupled through the hole 315, the hole 325, and the screw, and the hook fasteners 320 and the hooks 350 is described, but the present disclosure is not limited thereto. For example, the first housing part 131a and the second housing part 132a may be coupled by further using an adhesive material (e.g., an adhesive).

Referring to the example 305, when the first housing part 131a and the second housing part 132a are coupled, each of the FPCB 310 and the FPCB 340 may be at least partially exposed to the outside of the first housing part 131a and the second housing part 132a. For example, portions of each of the FPCB 310 and the FPCB 340 exposed to the outside of the first housing part 131a and the second housing part 132a may be connected to the PCB 215 in the inner portion the enclosure 110.

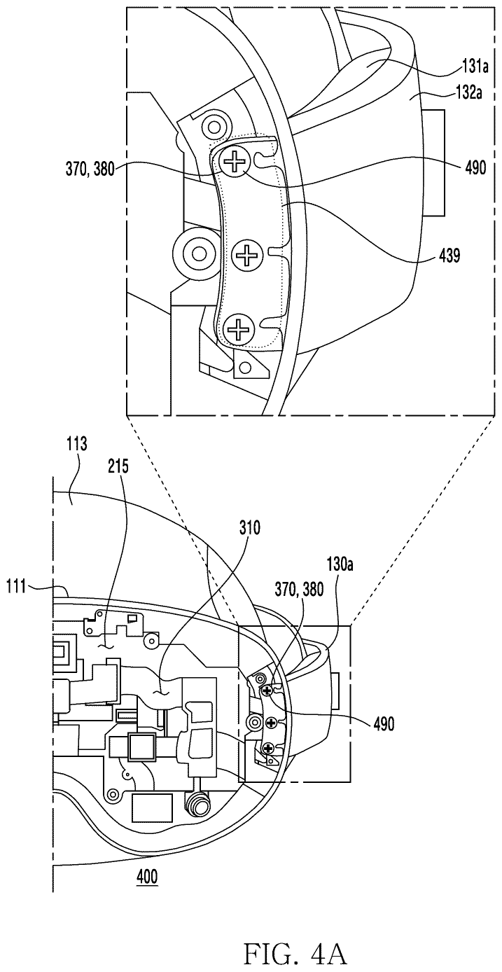

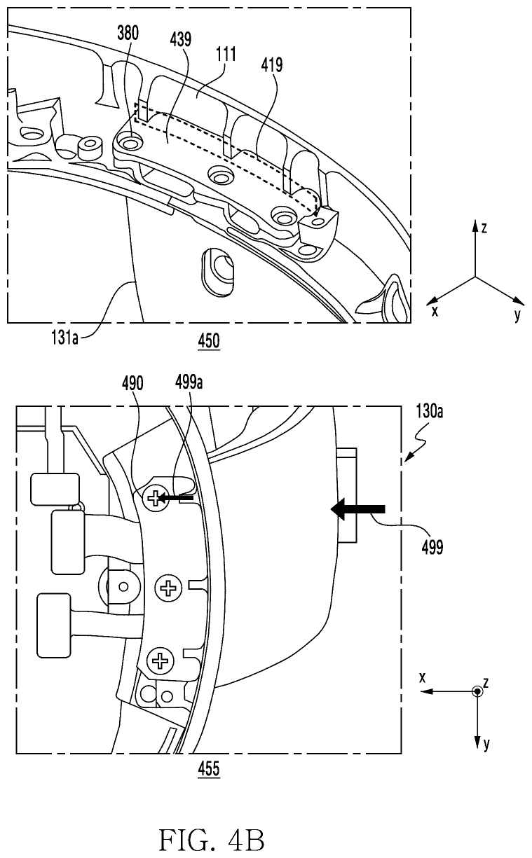

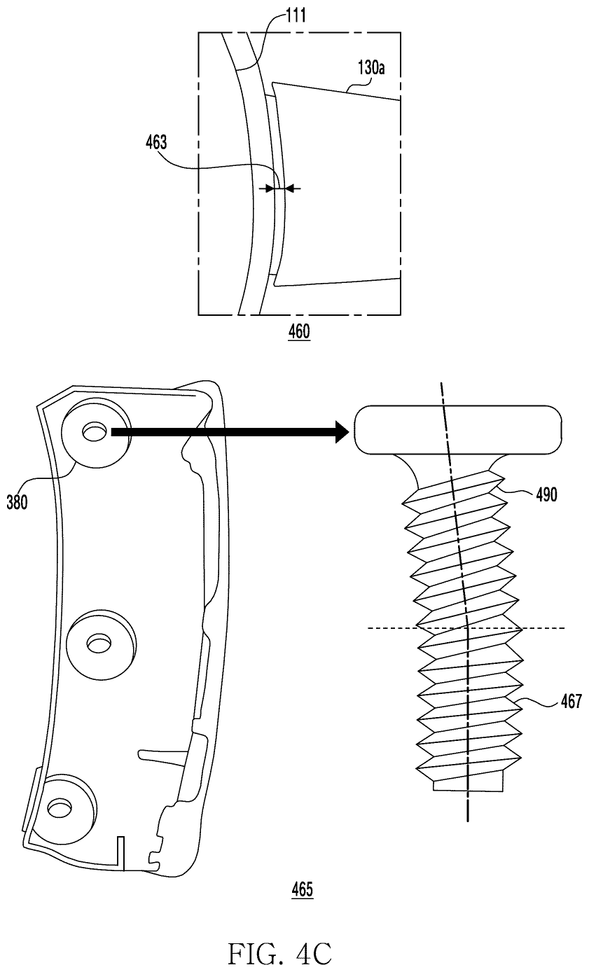

Referring to the example 306, the first housing part 131a may define (or include) a hole 370. The second housing part 132a may define (or include) a hole 380. For example, a portion (e.g., a portion 439 of FIG. 4A) of the first housing part 131a in which the hole 370 is defined may be positioned in an inner portion of the frame 111 of the enclosure 110 when the side band 130 is coupled with the enclosure 110. For example, the portion (e.g., the portion 439 of FIG. 4A) of the first housing part 131a in which the hole 370 is defined may be inserted (or embedded) into the inner portion of the frame 111 of the enclosure 110 when the side band 130 is coupled with the enclosure 110. For example, a portion (e.g., the portion 439 of FIG. 4A) of the second housing part 132a in which the hole 380 is defined may be positioned in the inner portion of the frame 111 of the enclosure 110 when the side band 130 is coupled with the enclosure 110. For example, the hole 380 may be aligned with the hole 370. Referring to the example 306, when the first housing part 131a and the second housing part 132a are coupled, the hole 315 may be aligned with the hole 325, and the hole 370 may be aligned with the hole 380.

As a non-limiting example, as illustrated in FIG. 3B, the first housing part 131a may define a plurality of holes including the hole 370 in the portion of the first housing part 131a, and the second housing part 132a may define a plurality of holes including the hole 380 in the portion of the second housing part 132a.

FIG. 4A includes a diagram and perspective view illustrating an example of a connection structure between an enclosure and a side band of a head-wearable electronic device according to various embodiments.

FIG. 4A illustrates an example 400 of a connection structure between an enclosure 110 and a side band 130 of a head-wearable electronic device 100. The example 400 may indicate a cross-section of a frame 111 cut to show an inner portion of the enclosure 110 with respect to the example 160 of FIG. 1C. In FIG. 4A, for convenience of explanation, a first housing part 131a and a second housing part 132a included in a housing 130a of the side band 130 are illustrated, but the present disclosure is not limited thereto. A description of FIG. 4A may be may be applied in substantially the same way to a first housing part 131b and a second housing part 132b included in a housing 130b.

Referring to the example 400, the side band 130 may be coupled with the enclosure 110. For example, the housing 130a of the side band 130 may be coupled with the frame 111 of the enclosure 110. As a non-limiting example, the housing 130a of the side band 130 may be coupled with an inner portion of the frame 111 through an opening (not illustrated) (e.g., an opening 419 of FIG. 4B) defined by the frame 111. An FPCB 310 (and/or an FPCB 340) extending from the housing 130a of the side band 130 passed through the opening of the frame 111 may be positioned within the enclosure 110. For example, the FPCB 310 may be connected (or electrically connected) to a PCB 215 of the enclosure 110.

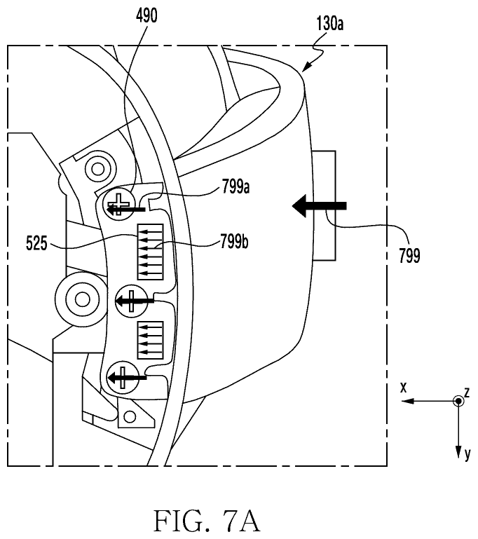

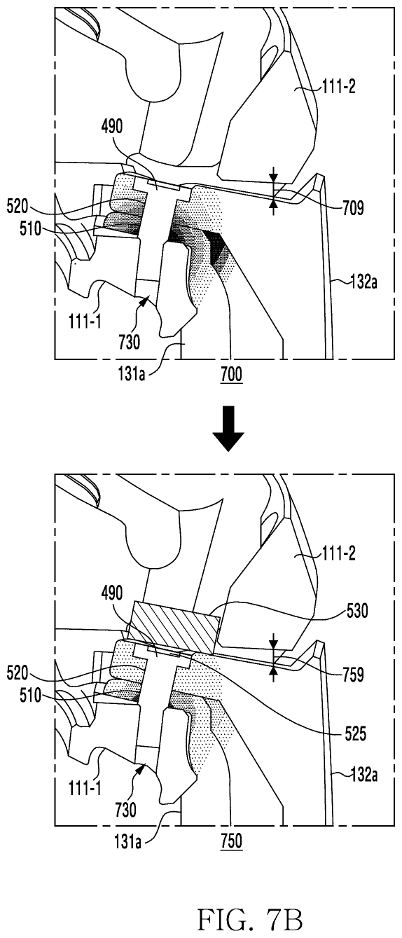

For example, a portion 439 of the housing 130a passed through the opening of the frame 111 may be contacted with the inner portion of the frame 111. For example, the housing 130a may be inserted (or embedded) into the inner portion of the frame 111 through the opening (e.g., the opening 419 of FIG. 4B) of the frame 111. For example, a screw 490 may couple the portion 439 of the housing 130a and the inner portion of the frame 111 through holes 370 and 380 of the housing 130a (or the hole 370 of the first housing part 131a and the hole 380 of the second housing part 132a). For example, the screw 490 may extend from the hole 380 of the second housing part 132a to the hole 370 (or a hole (e.g., a hole 730 of FIG. 7B) defined in the inner portion of the frame 111) of the first housing part 131a. For example, the side band 130 in which the portion 439 is positioned in the inner portion of the frame 111 may have a cantilever shape.

As a non-limiting example, the connection structure between the enclosure 110 and the side band 130 may include the holes 370 and 380, and the screw 490.

FIG. 4B includes a diagram and perspective view illustrating an example of a force transmitted to a connection structure between an enclosure and a side band by an external force applied to a head-wearable electronic device according to various embodiments.

FIG. 4B illustrates an example 450 illustrating a simplified connection state of the connection structure of FIG. 4A, and an example 455 of a force 499a transmitted to the connection structure of FIG. 4A by an external force 499 applied to the head-wearable electronic device 100. For example, the force 499a may be referred to as shear stress.

Referring to the example 450 of FIG. 4B, the portion 439 of the side band 130 passed through the opening 419 of the frame 111 of the enclosure 110 is illustrated. For convenience of explanation, the example 450 of FIG. 4B may indicate a case in which the screw 490 for coupling between the frame 111 of the enclosure 110 and the side band 130 is excluded. In the example 450, the first housing part 131a and the second housing part 132a may be contacted with the inner portion of the frame 111 in the portion 439 of the housing 130a.

Referring to the example 455 of FIG. 4B, the connection structure in which an xy-plane is viewed in a z-axis direction of the example 450 is illustrated. As a non-limiting example, the external force 499 may be applied in an x-axis direction with respect to the housing 130a. For example, the external force 499 may indicate a shock caused in a case in which the head-wearable electronic device 100 is dropped from a certain height. In a case in which the external force 499 is applied in the x-axis direction with respect to the housing 130a (or the second housing part 132a), the force 499a transmitted by the external force 499 may be caused in the x-axis direction penetrating the screw 490. For example, even if the external force 499 is applied with respect to the housing 130a, it may not only affect the outside of the head-wearable electronic device 100 but also affect the inside of the head-wearable electronic device 100 (or the inner portion of the enclosure 110). An example of deformation (or crack or damage) caused by the external force 499 (and the force 499a) is illustrated and described in greater detail with reference to FIG. 4C.

FIG. 4C includes diagrams illustrating examples of deformation caused in a connection structure between an enclosure and a side band by an external force applied to a head-wearable electronic device according to various embodiments.

FIG. 4C illustrates examples 460 and 465 of deformation caused in the connection structure between the enclosure 110 and the side band 130 caused by the external force 499 (and the force 499a of FIG. 4B).

Referring to the example 460, a gap 463 between the frame 111 of the enclosure 110 and the housing 130a of the side band 130 may be caused. For example, the gap 463 being caused may be generated by the side band 130 being spaced apart from the enclosure 110 by the external force 499, or may include an increase in a length of the gap 463. Referring to the example 465, bending may be caused in a portion 467 of the screw 490 passing through the hole 380, due to the force 499a transmitted by the external force 499.

Referring to FIG. 4C, the side band 130 may not only be directly affected by a shock (e.g., the external force 499) such as a drop, but the shock by the drop may also be transmitted (or concentrated) to the connection structure in which the side band 130 is connected to the enclosure 110. For example, in a case in which rigidity and fastening force of the connection structure are low, the gap 463 may be caused or the bending of the screw 490 may be caused.

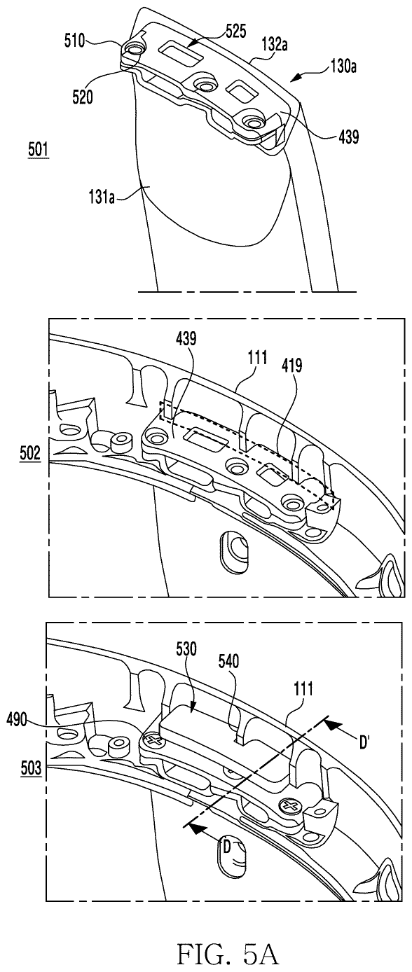

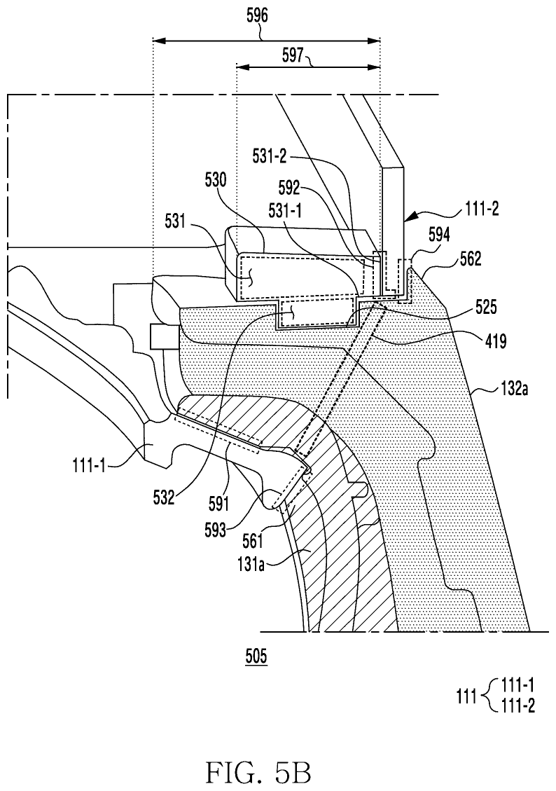

The present disclosure discloses a structure for reducing deformation by external shock by distributing a force (or shear stress) transmitted into the head-wearable electronic device 100 by external shock (e.g., the external force 499). For example, to reduce deformation by the external shock, a supporting member supporting the enclosure 110 and the side band 130 may be used. The connection structure between the enclosure 110 and the side band 130 may include the supporting member. An example of the connection structure of the head-wearable electronic device 100 including the supporting member may be referenced in FIGS. 5A and 5B.

FIG. 5A includes perspective views illustrating an example of a connection structure between an enclosure and a side band of a head-wearable electronic device including a supporting member according to various embodiments.

FIG. 5A illustrates an example 501 of a housing 130a that includes a second housing part 132a defining a groove 525, an example 502 of a frame 111 contacted with the housing 130a through an opening 419 of the frame 111 of an enclosure 110, and an example 503 of the connection structure including a supporting member 530 attached to a portion (e.g., a second housing part 132a) of the housing 130a in a state in which the housing 130a and the frame 111 are in contact. In FIG. 5A, for convenience of explanation, a first housing part 131a and the second housing part 132a included in the housing 130a of a side band 130 are illustrated, but the present disclosure is not limited thereto. A description of FIG. 5A may be may be applied in substantially the same way to a first housing part 131b and a second housing part 132b included in a housing 130b.

Referring to the example 501, the first housing part 131a may be coupled with the second housing part 132a. As a non-limiting example, the first housing part 131a may be connected to the second housing part 132a through a screw passing through a hole (e.g., the hole 315 of FIG. 3A) of the first housing part 131a and a hole (e.g., the hole 325 of FIG. 3A) of the second housing part 132a. As a non-limiting example, the first housing part 131a may be connected to the second housing part 132a through hooks (e.g., the hooks 350 of FIG. 3A) of the second housing part 132a that are coupled with loops (e.g., the hook fasteners 320 of FIG. 3A) of the first housing part 131a. As a non-limiting example, the first housing part 131a may be connected to the second housing part 132a through an adhesive material.

Referring to the example 501, the first housing part 131a may define (or include) a hole 510. For example, the hole 510 may be an example of the hole 370 defined by the first housing part 131a of FIG. 3B. The second housing part 132a may define (or include) a hole 520. For example, the hole 520 may be an example of the hole 380 defined by the second housing part 132a of FIG. 3B. For example, the hole 510 and the hole 520 may be defined in a portion 439 of the housing 130a positioned in the frame 111 when the enclosure 110 and the side band 130 are coupled.

Referring to the example 501, the second housing part 132a may define (or include) the groove 525. For example, the groove 525 may be defined by the second housing part 132a in the portion 439 of the housing 130a. The groove 525 may be referred to as a recess, an opening, or a concave portion. As a non-limiting example, the second housing part 132a may define a plurality of grooves. For example, in the example 501 of FIG. 5A, the second housing part 132a may define two grooves.

Referring to the example 502, the housing 130a in which the first housing part 131a and the second housing part 132a are coupled may be contacted with an inner portion of the frame 111 through the opening 419 of the frame 111. For example, the portion 439 of the housing 130a may be contacted with the inner portion of the frame 111.

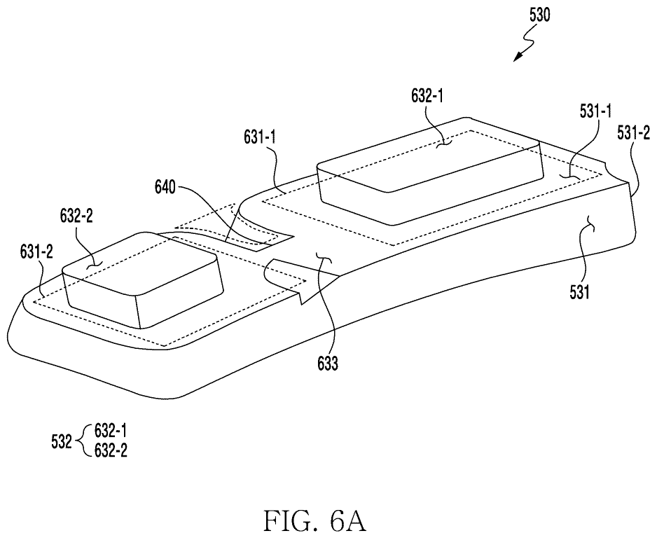

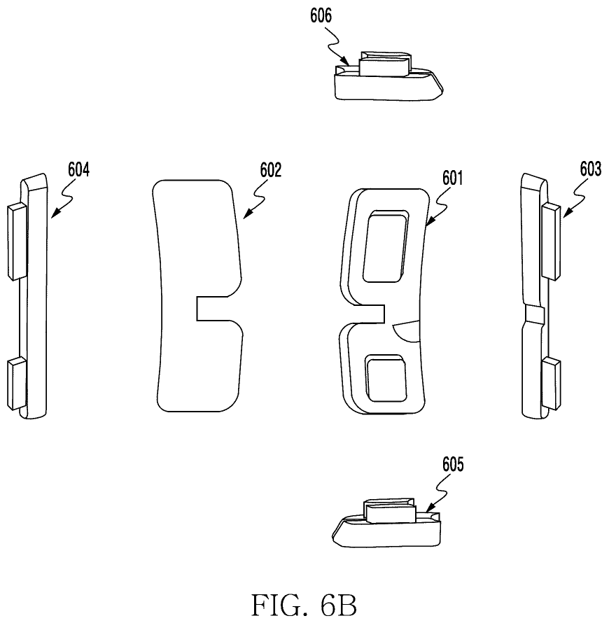

Referring to the example 503, in a state in which the portion 439 is contacted with the inner portion of the frame 111, the supporting member 530 may be disposed on the second housing part 132a such that at least a portion of the supporting member 530 is attached to the groove 525 of the second housing part 132a. For example, the at least portion of the supporting member 530 disposed at the groove 525 may be referred to as a protrusion portion of the supporting member 530. An example of the protrusion portion of the supporting member 530 is illustrated and described below with reference to FIG. 5B. For example, at least a portion of the supporting member 530 may fit in a convex portion 540 protruding (or extending) from the frame 111 toward the inner portion of the frame 111. For example, the at least portion of the supporting member 530 that fits in the convex portion 540 may be referred to as a concave portion. For example, an example of the concave portion of the supporting member 530 is illustrated and described below with reference to FIG. 6A.

FIG. 5B is a cross-sectional view illustrating an example of a connection state of a connection structure including a supporting member according to various embodiments.

FIG. 5B illustrates an example 505 of a connection state of the connection structure including the supporting member 530 of FIG. 5A. The example 505 is a cross-section of the enclosure 110 (or the frame 111) and the side band 130 (or the housing 130a) cut along line D-D′ of the example 503 of FIG. 5A.

Referring to the example 505, the housing 130a may be contacted with the inner portion of the frame 111 through the opening 419 of the frame 111. For example, the first housing part 131a of the housing 130a may be contacted with an inner portion 591 of a first portion 111-1 of the frame 111. For example, the second housing part 132a of the housing 130a may be contacted with an inner portion 592 of a second portion 111-2 of the frame 111. However, the present disclosure is not limited thereto. For example, the housing 130a may be contacted with an outer portion of the frame 111. For example, the first housing part 131a may be contacted with an outer portion 593 of the frame 111. At this time, the first housing part 131a may include a portion 561 formed to support (or surround) the outer portion 593 of the frame 111 when the housing 130a passes through the opening 419 of the frame 111. For example, the portion 561 may have a shape corresponding to a shape of the outer portion 593 of the frame 111. For example, the second housing part 132a may be contacted with an outer portion 594 of the frame 111. At this time, the second housing part 132a may include a portion 562 formed to support (or surround) an outer portion 594 of the frame 111 when the housing 130a passes through the opening 419 of the frame 111. For example, the portion 562 may have a shape corresponding to a shape of the outer portion 594 of the frame 111. Coupling force between the enclosure 110 and the side band 130 may be increased by the first housing part 131a including the portion 561 and the second housing part 132a including the portion 562.

Referring to the example 505, the supporting member 530 may include a base portion 531 and a protrusion portion 532 extending (or protruding) from the base portion. The protrusion portion 532 may be referred to as a wedge, a tongue, or a convex portion. For example, the protrusion portion 532 may extend from the base portion 531 to the groove 525. The supporting member 530 may be attached to the groove 525 of the second housing part 132a. For example, the protrusion portion 532 of the supporting member 530 may be attached to the groove 525 of the second housing part 132a through an adhesive member. The adhesive member may be disposed between the protrusion portion 532 and the groove 525. As a non-limiting example, the adhesive member may include an adhesive tape. As a non-limiting example, the adhesive member may include a rivet. As a non-limiting example, the adhesive member may include a screw. As a non-limiting example, the protrusion portion 532 may be attached to the groove 525 of the second housing part 132a according to a process for adhesion. As a non-limiting example, the process may include bonding, welding, or fusion.

For example, the base portion 531 may include a first portion 531-1 disposed peripherally to the protrusion portion 532, and a second portion 531-2 extending from the first portion 531-1 and substantially perpendicular to the first portion 531-1. For example, the first portion 531-1 of the base portion 531 may be contacted with the second housing part 132a. For example, the second portion 531-2 of the base portion 531 may be contacted with the inner portion 592 of the second portion 111-2 of the frame 111. In FIG. 5B, since the second portion 111-2 of the frame 111 is a plane, the base portion 531 including the second portion 531-2 that is substantially perpendicular to the first portion 531-1 is illustrated, but the present disclosure is not limited thereto. In a case in which the second portion 111-2 of the frame 111 is a curved surface, the second portion 531-2 of the base portion 531 may extend from the first portion 531-1 and may have a shape (e.g., a curved surface) corresponding to the curved surface of the second portion 111-2.

In the example 505, it is illustrated that a length 597 of the base portion 531 of the supporting member 530 is shorter than a length 596 of the second housing part 132a positioned in the frame 111, but the present disclosure is not limited thereto. For example, the length 597 may correspond to (or be equal to) the length 596. An example of a structure of the supporting member 530 of FIGS. 5A and 5B may be referenced in FIGS. 6A and 6B.

FIGS. 6A and 6B are perspective views of illustrating an example supporting member according to various embodiments.

FIG. 6A is a perspective view of an example of a supporting member 530. For example, the supporting member 530 may be an example of the supporting member 530 of FIGS. 5A and 5B.

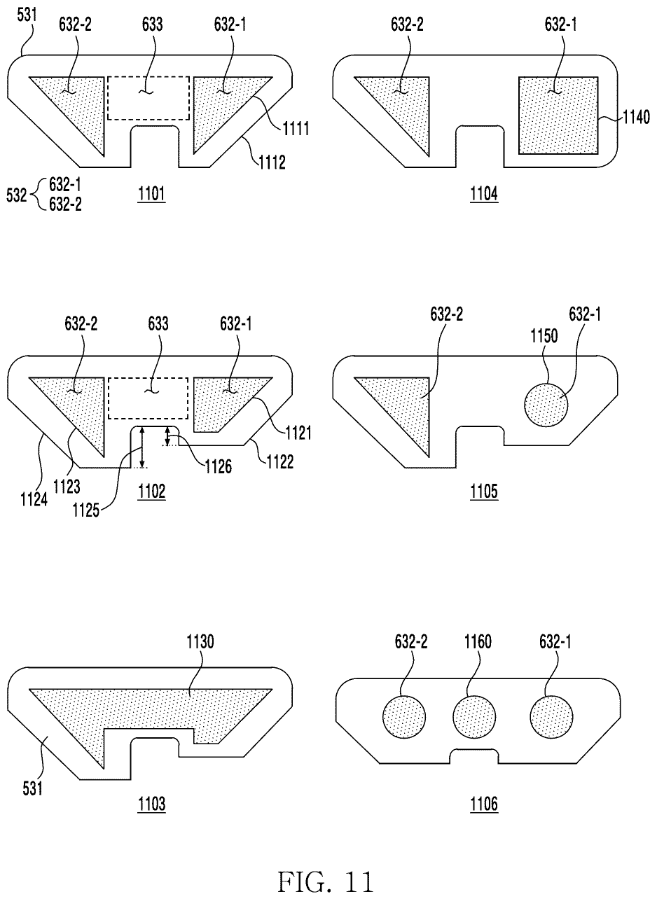

Referring to FIG. 6A, the supporting member 530 may include a base portion 531 and a protrusion portion 532. As a non-limiting example, the protrusion portion 532 may include a first protrusion portion 632-1 and a second protrusion portion 632-2. In an example of FIG. 6A, the protrusion portion 532 including two protrusion portions 632-1 and 632-2 is illustrated, but the present disclosure is not limited thereto. Examples of various shapes of the supporting member 530 may be referenced in FIG. 11. As a non-limiting example, the supporting member 530 may be formed of a metal material. In addition, as a non-limiting example, the supporting member 530 may be formed of a resin.

For example, the first protrusion portion 632-1 may extend (or protrude) from a region 631-1 of the base portion 531. The second protrusion portion 632-2 may extend (or protrude) from a region 631-2 of the base portion 531. For example, a region 633 may be positioned between the region 631-1 and the region 631-2 of the base portion 531.

For example, the base portion 531 may include a first portion 531-1 disposed peripherally to the protrusion portion 532 (or the first protrusion portion 632-1 and the second protrusion portion 632-2), and a second portion 531-2 extending from the first portion 531-1 and substantially perpendicular to the first portion 531-1. For example, the base portion 531 may include a concave portion 640. For example, the concave portion 640 may be defined by the region 633 of the base portion 531. As a non-limiting example, the concave portion 640 may be aligned with a protrusion portion (e.g., the protrusion portion 532 of FIG. 5A) of a frame 111 of an enclosure 110. For example, the concave portion 640 may fit in the protrusion portion of the frame 111.

As a non-limiting example, a size of the first protrusion portion 632-1 may be different from a size of the second protrusion portion 632-2. In the example of FIG. 6A, the size of the first protrusion portion 632-1 may be larger than the size of the second protrusion portion 632-2. However, the present disclosure is not limited thereto. The size of the first protrusion portion 632-1 may be equal to or smaller than the size of the second protrusion portion 632-2.

In addition, as a non-limiting example, a shape of the first protrusion portion 632-1 may substantially correspond to (or be equal to) a shape of the second protrusion portion 632-2. In the example of FIG. 6A, each of the shape of the first protrusion portion 632-1 and the shape of the second protrusion portion 632-2 may have a quadrangular prism shape. However, the present disclosure is not limited thereto. For example, the shape of the first protrusion portion 632-1 may be different from the shape of the second protrusion portion 632-2. An example related to this may be referenced in FIG. 11.

FIG. 6B illustrates an example 601 of a case in which the supporting member 530 of FIG. 6A is viewed from an upper end, an example 602 of a case in which it is viewed from a lower end, an example 603 of a case in which it is viewed from a left side, an example 604 of a case in which it is viewed from a right side, an example 605 of a case in which it is viewed from a front surface, and an example 606 of a case in which it is viewed from a rear surface. Referring to the examples 601, 602, 603, 604, 605, and 606 of FIG. 6B, a lower end surface of the base portion 531 may have a flat shape, and an upper end surface of the protrusion portion 532 may have a flat shape.

Referring to FIGS. 6A and 6B, the supporting member 530 may be formed in a wedge structure. Using the supporting member 530 formed in the wedge structure, distribution of force by an external force may be easily performed even in a narrow disposition region. For example, by inserting and attaching the supporting member 530 formed in the wedge structure into a groove 525 of a housing 130a (or a second housing part 132a) of a side band 130, slip may be prevented and/or reduced and shear stress may be improved, compared to simply surrounding the housing 130a through a band-shaped reinforcing structure or using a screw.

FIG. 7A is a perspective view illustrating an example of a force transmitted to a connection structure between an enclosure and a side band including a supporting member by an external force applied to a head-wearable electronic device according to various embodiments.

FIG. 7A illustrates an example of a force 799a or 799b transmitted to a simplified connection structure of the connection structure of FIG. 5A, including a supporting member 530, by an external force 799 applied to a head-wearable electronic device 100.

In FIG. 7A, for convenience of explanation, the supporting member 530 is not shown, but it is assumed that the supporting member 530 is attached to a groove 525 of a housing 130a.

Referring to FIG. 7A, the external force 799 may be applied in an x-axis direction with respect to the housing 130a. For example, the external force 799 may indicate a shock caused in a case in which the head-wearable electronic device 100 is dropped from a certain height. In case in which the external force 799 is applied in the x-axis direction with respect to the housing 130a (or a second housing part 132a), the force 799a transmitted by the external force 799 may be caused in the x-axis direction penetrating a screw 490. In addition, in a case in which the external force 799 is applied in the x-axis direction with respect to the housing 130a (or the second housing part 132a), the force 799b transmitted by the external force 799 may be caused in the x-axis direction penetrating the groove 525 and the supporting member 530. For example, the force 799b may penetrate the groove 525 and a protrusion portion (e.g., the protrusion portion 532 of FIG. 5B) of the supporting member 530.

In FIG. 7A, the external force 799 may be distributed into the force 799a in the x-axis direction penetrating the screw 490 and the force 799b in the x-axis direction penetrating the groove 525. Accordingly, deformation caused by the external force 799 may be reduced. In addition, deformation may be caused when higher magnitude of the external force 799 is applied to the head-wearable electronic device 100.

For each of the connection structure illustrated in the example 455 of FIG. 4B and the connection structure including the supporting member 530 illustrated in FIG. 7A, examples of deformation caused in a case in which force according to the same external force is transmitted may be referred to FIG. 7B.

FIG. 7B includes diagrams illustrating examples of deformation caused in a connection structure between an enclosure and a side band by an external force applied to a head-wearable electronic device according to various embodiments.

FIG. 7B illustrates an example 700 of deformation caused in the connection structure of FIG. 4B by a force (e.g., a force 499a) transmitted from an external force (e.g., the external force 499a of FIG. 4B) and an example 750 of deformation caused in the connection structure of FIG. 7A by a force (e.g., the force 799a and the force 799b) transmitted from an external force (e.g., the external force 799 of FIG. 7B).

Referring to the example 700 and the example 750, the housing 130a may be contacted with an inner portion of a frame 111 through an opening (e.g., the opening 419 of FIG. 4A) of the frame 111. For example, a first housing part 131a of the housing 130a may be contacted with an inner portion of a first portion 111-1 of the frame 111. For example, a second housing part 132a of the housing 130a may be contacted with an inner portion of a second portion 111-2 of the frame 111. The screw 490 may couple the housing 130a and the frame 111 through holes 510 and 520 of the housing 130a (or the hole 510 of the first housing part 131a and the hole 520 of the second housing part 132a) and a hole 730 defined in the first portion 111-1 of the frame 111. For example, the screw 490 may extend from the hole 520 of the second housing part 132a to the hole 730 defined in the first portion 111-1 of the frame 111. Referring to the example 750, unlike the example 700, the groove 525 may be defined in the second housing part 132a. For example, the supporting member 530 may be attached to the groove 525.

Referring to the example 700, a gap 709 between the housing 130a and the frame 111 may be caused by an external force applied to the housing 130a. For example, the gap 709 may be caused between the second portion 111-2 of the frame 111 and the second housing part 132a.

Referring to the example 750, a gap 759 between the housing 130a and the frame 111 may be caused by an external force applied to the housing 130a. It is assumed that magnitude of the external force applied to the housing 130a in the example 750 is the same as or similar to a magnitude of the external force applied to the housing 130a in the example 700. For example, the gap 759 may be caused between the second portion 111-2 of the frame 111 and the second housing part 132a.

The gap 759 may be narrower than the gap 709. For example, using the connection structure including the supporting member 530, deformation caused by the external force applied to the housing 130a may be reduced.

In addition, the external force applied to the housing 130a may cause a load on the housing 130a (e.g., the first housing part 131a and the second housing part 132a) peripheral to the screw 490. The load may cause bending of the screw 490. The load caused on the housing 130a peripheral to the screw 490 in the example 750 may be lower than the load caused on the housing 130a around the screw 490 in the example 700. Accordingly, the screw 490 of the example 750 may be less bent than the screw 490 of the example 700.

As a non-limiting example, compared to the head-wearable electronic device 100 including the supporting member 530 formed of a resin, less deformation may be caused in the head-wearable electronic device 100 including the supporting member 530 formed of a metal material. For example, compared to the head-wearable electronic device 100 including the supporting member 530 made of a resin, the head-wearable electronic device 100 including the supporting member 530 made of a metal material may be damaged by an external force with larger magnitude.

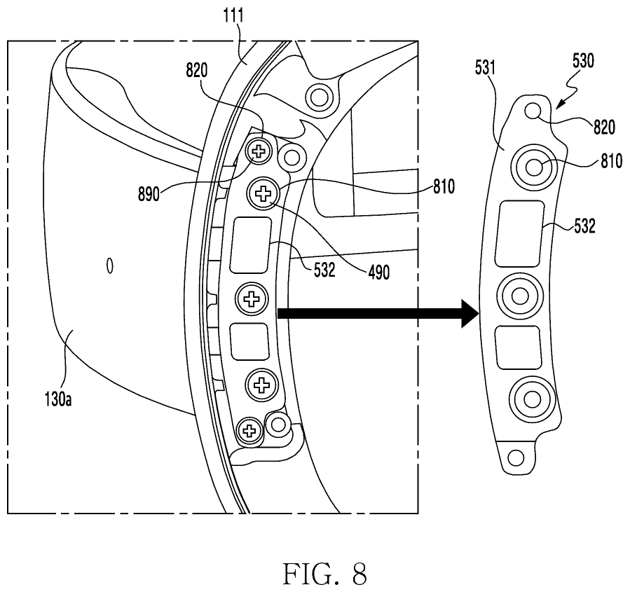

FIG. 8 is a diagram illustrating an example supporting member including a hole for a screw according to various embodiments.

FIG. 8 illustrates an example of a supporting member 530 including holes 810 and 820 for a screw. For example, the supporting member 530 may include a hole 810 and a hole 820. For example, the hole 810 and the hole 820 may be disposed in a base portion 531 in which a protrusion portion 532 of the supporting member 530 is not disposed. The hole 810 may be spaced apart from the protrusion portion 532. The hole 820 may be spaced apart from the hole 810.

Referring to FIG. 8, a screw 490 may connect the supporting member 530, a housing 130a (or a first housing part 131a and a second housing part 132a), and a frame 111 through the hole 810. For example, the screw 490 may connect the supporting member 530, the housing 130a (or the first housing part 131a and the second housing part 132a), and the frame 111 through the hole 810, holes (e.g., the holes 370 and 380 of FIG. 3B or the holes 510 and 520 of FIG. 5A)of the housing 130a, and a hole (e.g., the hole 730 of FIG. 7B) of the frame 111. For example, the screw 490 may extend from the hole 810 to the hole (e.g., the hole 730 of FIG. 7B) of the frame 111 via the holes (e.g., the holes 370 and 380 of FIG. 3B or the holes 510 and 520 of FIG. 5A) of the housing 130a.

Referring to FIG. 8, a screw 890 may connect the supporting member 530 and the frame 111 through the hole 820. For example, the screw 890 may connect the supporting member 530 and the frame 111 through the hole 810 and another hole (e.g., the hole 730 of FIG. 7B) of the frame 111. For example, the screw 890 may extend from the hole 810 to the other hole (e.g., the hole 730 of FIG. 7B) of the frame 111. In an example of FIG. 8, It is described that the screw 890 passes through the hole 810 and the other hole (e.g., the hole 730 of FIG. 7B) of the frame 111, but the present disclosure is not limited thereto. For example, the screw 890 may connect the supporting member 530, the housing 130a (or the first housing part 131a and the second housing part 132a), and the frame 111 through the hole 820, the holes (e.g., the holes 370 and 380 of FIG. 3B or the holes 510 and 520 of FIG. 5A) of the housing 130a, and the hole (e.g., the hole 730 of FIG. 7B) of the frame 111.

Using the supporting member 530 including (or defining) the holes 810 and 820 of FIG. 8, the supporting member 530 may be fixed to the housing 130a. Accordingly, even if an external force is applied to a head-wearable electronic device 100, the supporting member 530 may be prevented/reduced from being spaced apart from the housing 130a. By fixing the supporting member 530 to the housing 130a, even if an external force is applied to the head-wearable electronic device 100, occurrence of a gap between an enclosure 110 and a side band 130 may be prevented (or reduced).

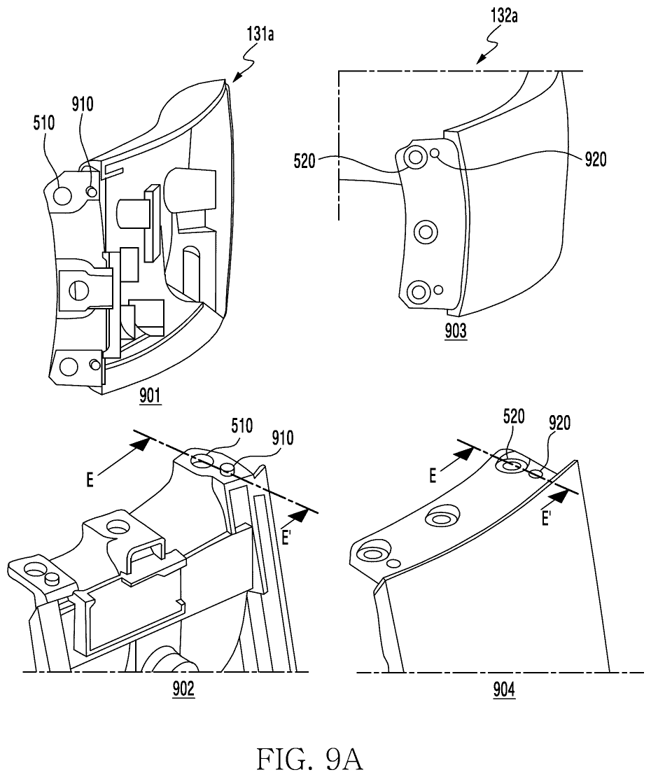

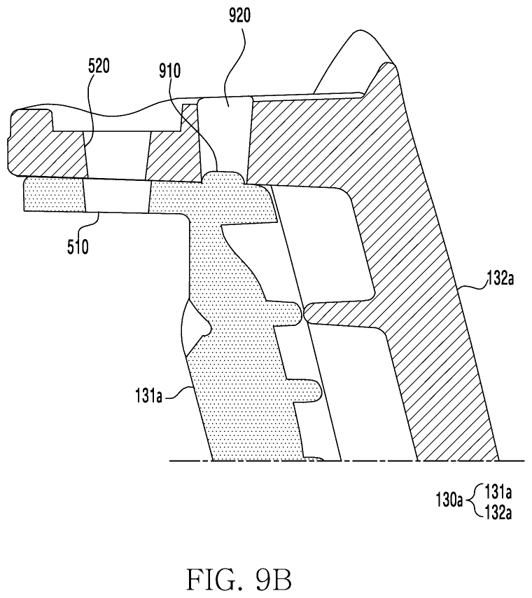

FIG. 9A includes perspective views illustrating an example of a fixing structure between a first housing part and a second housing part of a side band according to various embodiments. In FIG. 9A, for convenience of explanation, a first housing part 131a and a second housing part 132a included in a housing 130a of a side band 130 are illustrated, but the present disclosure is not limited thereto. A description of FIG. 5A may be applied in substantially the same way to a first housing part 131b and a second housing part 132b included in a housing 130b.

FIG. 9A are perspective views illustrating examples 901 and 902 of the first housing part 131a further including a convex portion 910, and examples 903 and 904 of the second housing part 132a further including a concave portion 920.

Referring to the examples 901 and 902, the first housing part 131a may define (or include) a hole 510. For example, the first housing part 131a may define (or include) the convex portion 910 spaced apart from the hole 510. In the examples 901 and 902 of FIG. 9A, the first housing part 131a is illustrated as defining (or including) three holes and two convex portions, but the present disclosure is not limited thereto. For example, the hole 510 and the convex portion 910 may be defined in a portion 439 of the housing 130a positioned in a frame 111 when an enclosure 110 and the side band 130 are coupled. For example, the convex portion 910 may be referred to as a wedge, a tongue, or a protrusion portion.

Referring to the examples 903 and 904, the second housing part 132a may define (or include) a hole 520. For example, the first housing part 131a may define (or include) the concave portion 920 spaced apart from the hole 520. For example, the concave portion 920 may be referred to as a recess, a hole, or an opening. In the examples 903 and 904 of FIG. 9A, the second housing part 132a is illustrated as defining (or including) three holes and two concave portions, but the present disclosure is not limited thereto. For example, the hole 520 and the concave portion 920 may be defined in the portion 439 of the housing 130a positioned in the frame 111 when the enclosure 110 and the side band 130 are coupled.

For example, the convex portion 910 and the concave portion 920 may be referred to as a fixing structure for fixing between the first housing part 131a and the second housing part 132a. Hereinafter, FIG. 9B illustrates an example of a connection state of the fixing structure.

FIG. 9B is a cross-sectional view illustrating an example of a connection state of a fixing structure between a first housing part and a second housing part of a side band according to various embodiments.

FIG. 9B is a cross-sectional view of the housing 130a taken along line E-E′ of the example 903 and the example 904 of FIG. 9A.

Referring to FIG. 9B, when the first housing part 131a and the second housing part 132a are coupled, the convex portion 910 of the first housing part 131a may fit in the concave portion 920 of the second housing part 132a. For example, the convex portion 910 of the first housing part 131a may be defined in the first housing part 131a so as to be aligned with the concave portion 920 of the second housing part 132a. Although not illustrated in FIG. 9B, a screw (e.g., the screw 490 of FIG. 5A) may couple the first housing part 131a and the second housing part 132a through the holes 510 and 520.

Referring to FIGS. 9A and 9B, a slip between the first housing part 131a and the second housing part 132a may be reduced (or prevented) using the fixing structure including the convex portion 910 and the concave portion 920 together with the screw. In addition, as coupling force between the first housing part 131a and the second housing part 132a is increased using the fixing structure, distribution of force in the housing 130a and the frame 111 may be easily performed. Accordingly, even if an external force is applied to a head-wearable electronic device 100, occurrence of a gap between the enclosure 110 and the side band 130 may be prevented (or reduced).

Shapes of each of the convex portion 910 and the concave portion 920 illustrated in FIGS. 9A and 9B are merely examples for convenience of explanation, and the present disclosure is not limited thereto.

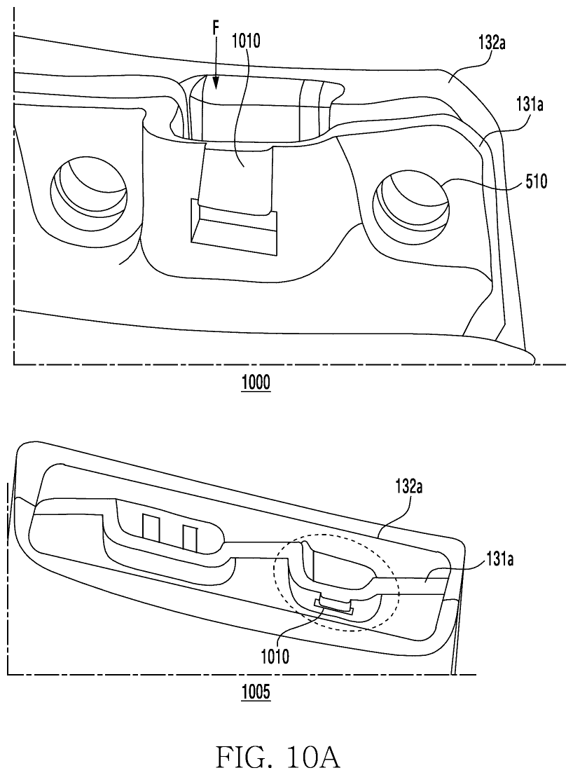

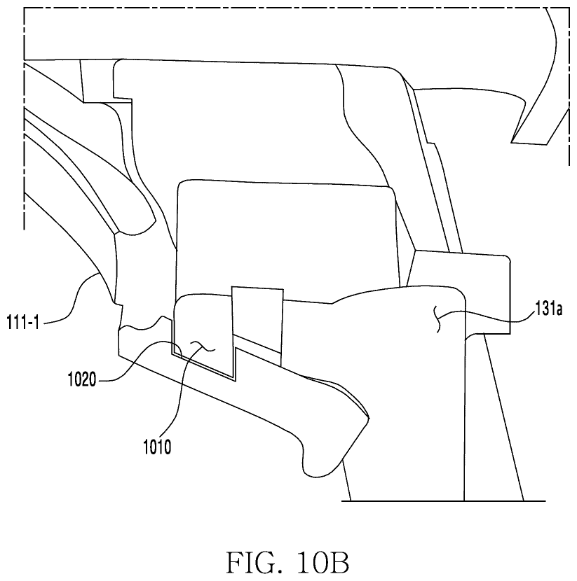

FIG. 10A includes perspective views illustrating an example of a fixing structure between a first housing part of the side band and a frame of an enclosure according to various embodiments.

In FIG. 10A, for convenience of explanation, a first housing part 131a and a second housing part 132a included in a housing 130a of a side band 130 are illustrated, but the present disclosure is not limited thereto. A description of FIG. 10A may be may be applied in substantially the same way to a first housing part 131b and a second housing part 132b included in a housing 130b.

FIG. 10A includes perspective views illustrating examples 1000 and 1005 of the housing 130a in which the first housing part 131a further including a convex portion 1010 and the second housing part 132a are coupled.

Referring to the example 1000, the first housing part 131a may include the convex portion 1010. For example, the convex portion 1010 may be disposed (or formed) on a surface, among surfaces of the first housing part 131a, opposite to a surface facing the second housing part 132a when the first housing part 131a is coupled with the second housing part 132a. For example, among the surfaces of the first housing part 131a, the surface on which the convex portion 1010 is disposed may be a surface facing a frame 111 (or a first portion 111-1 of the frame 111). For example, the convex portion 1010 may be spaced apart from a hole 510 defined by the first housing part 131a. For example, the convex portion 1010 may be referred to as a wedge, a tongue, or a protrusion portion.

The example 1005 illustrates an example in a case in which the housing 130a of the example 1000 is viewed from an F direction. As described above, the convex portion 1010 may be disposed on the surface, among the surfaces of the first housing part 131a, opposite to the surface facing the second housing part 132a. The convex portion 1010 of the first housing part 131a may be coupled with (or contacted to) a concave portion (e.g., a concave portion 1020 of FIG. 10B) of the frame 111 of an enclosure 110. An example of the coupling between the convex portion 1010 and the frame 111 may be referenced in FIG. 10B below. For example, the convex portion 1010 and the concave portion 1020 may be referred to as a fixing structure for fixing between the first housing part 131a and the frame 111. Hereinafter, FIG. 10B illustrates an example of a connection state of the fixing structure.

FIG. 10B is a diagram illustrating an example of a connection state of a fixing structure between a first housing part of a side band and a frame of an enclosure according to various embodiments.

FIG. 10B illustrates an example of a connection state of the fixing structure between the housing 130a and the frame 111 of the example 1000 of FIG. 10A.

Referring to FIG. 10B, when the housing 130a and the frame 111 are coupled, the convex portion 1010 of the first housing part 131a may fit in the concave portion 1020 of the frame 111. For example, the concave portion 1020 may be included (or formed or defined) in the first portion 111-1 of the frame 111. For example, the convex portion 1010 of the first housing part 131a may be defined in the first housing part 131a to be aligned with the concave portion 1020 of the frame 111 (or the first portion 111-1 of the frame 111). For example, the concave portion 1020 may be referred to as a recess, a hole, or an opening.

Referring to FIGS. 10A and 10B, a slip between the first housing part 131a and the first portion 111-1 of the frame 111 may be reduced (or prevented) using the fixing structure including the convex portion 1010 and the concave portion 1020 together with a screw (e.g., a screw 490) for coupling the housing 130a and the frame 111. In addition, as coupling force between the first housing part 131a (or the housing 130a) and the first portion 111-1 of the frame 111 (or the frame 111) is increased using the fixing structure, distribution of force in the housing 130a and the frame 111 may be easily performed. Accordingly, even if an external force is applied to the head-wearable electronic device 100, occurrence of a gap between the enclosure 110 and the side band 130 may be prevented (or reduced).

Shapes of each of the convex portion 1010 and the concave portion 1020 illustrated in FIGS. 10A and 10B are merely examples for convenience of explanation, and the present disclosure is not limited thereto.

FIG. 11 is a diagram illustrating examples of a supporting member according to various embodiments.

FIG. 11 illustrates examples 1101, 1102, 1103, 1104, 1105, and 1106 of various shapes of the supporting member 530 of FIG. 6A. Each of the examples 1101, 1102, 1103, 1104, 1105, and 1106 of FIG. 11 may be plan views of the supporting member 530 viewed from an upper end.

Referring to the example 1101, the supporting member 530 may include a base portion 531 and a protrusion portion 532. As a non-limiting example, the protrusion portion 532 may include a first protrusion portion 632-1 and a second protrusion portion 632-2. For example, each of the first protrusion portion 632-1 and the second protrusion portion 632-2 may have a triangular prism shape. An exterior of the base portion 531 of the supporting member 530 may be formed along an exterior of the protrusion portion 532. For example, a shape of a portion 1112 of the base portion 531 may be formed to substantially correspond to (or be parallel to) a shape of a portion 1111 of the first protrusion portion 632-1. The supporting member 530 may have a shape for forming a concave portion 640 in a region 633 of the base portion 531 extending from the portion 1112 of the base portion 531. Referring to the example 1101, the second protrusion portion 632-2 and the base portion 531 adjacent to the second protrusion portion 632-2 may substantially correspond to shapes of the first protrusion portion 632-1 and the base portion 531 adjacent to the first protrusion portion 632-1. For example, the supporting member 530 may have a symmetrical shape.

Referring to the example 1102, the supporting member 530 may include the base portion 531 and the protrusion portion 532. As a non-limiting example, the protrusion portion 532 may include the first protrusion portion 632-1 and the second protrusion portion 632-2. For example, the first protrusion portion 632-1 may have a quadrangular prism shape, and the second protrusion portion 632-2 may have a triangular prism shape. Unlike the example 1101, a shape of the first protrusion portion 632-1 of the example 1102 may be different from a shape of the second protrusion portion 632-2. The exterior of the base portion 531 of the supporting member 530 may be formed along the exterior of the protrusion portion 532. For example, a shape of a portion 1122 of the base portion 531 may be formed to substantially correspond to (or be parallel to) a shape of a portion 1121 of the first protrusion portion 632-1. For example, a shape of a portion 1124 of the base portion 531 may be formed to substantially correspond to (or be parallel to) a shape of a portion 1123 of the second protrusion portion 632-2. The supporting member 530 may have the shape for forming the concave portion 640 in the region 633 of the base portion 531 extending from each of the portion 1122 and the portion 1124 of the base portion 531. For example, the concave portion 640 may have a shape in which a length 1126 of a region adjacent to the portion 1122 of the base portion 531 and a length 1125 of a region adjacent to the portion 1124 of the base portion 531 are different from each other. This may be because the first protruding portion 632-1 and the second protruding portion 632-2 have different shapes. For example, the supporting member 530 may have an asymmetric shape.

Referring to the example 1103, the supporting member 530 may include the base portion 531 and a protrusion portion 1130. Unlike the protrusion portion 532 of the example 1101 and the example 1102, the protrusion portion 1130 of the example 1103 may be one protrusion portion. For example, the protrusion portion 1130 may have a shape in which the first protrusion 632-1 and the second protrusion 632-2 of the example 1102 are connected. The protrusion portion 1130 of the example 1103 may further include an additional protrusion portion extending the first protrusion 632-1 and the second protrusion 632-2, on the region 633 between the first protrusion 632-1 and the second protrusion 632-2 of the example 1102.

Referring to the example 1104, the supporting member 530 may include the base portion 531 and the protrusion portion 532. As a non-limiting example, the protrusion portion 532 may include the first protrusion portion 632-1 and the second protrusion portion 632-2. For example, the first protrusion portion 632-1 may have a quadrangular prism shape 1140, and the second protrusion portion 632-2 may have a triangular prism shape. The quadrangular prism shape 1140 of the first protrusion portion 632-1 of the example 1104 may be different from the quadrangular prism shape of the first protrusion portion 632-1 of the example 1102. For example, the quadrangular prism shape 1140 of the first protrusion portion 632-1 of the example 1104 may be square when the supporting member 530 is viewed from the upper end. In contrast, the quadrangular prism shape of the first protrusion portion 632-1 of the example 1102 may be trapezoidal when the supporting member 530 is viewed from the upper end. The quadrangular prism shape 1140 of the first protrusion portion 632-1 of the example 1104 may be a structure for increasing a contact region between the supporting member 530 and a groove (e.g., the groove 525 of FIG. 5A) of a second housing part (e.g., a second housing part 132a).

Referring to the example 1105, the supporting member 530 may include the base portion 531 and the protrusion portion 532. As a non-limiting example, the protrusion portion 532 may include the first protrusion portion 632-1 and the second protrusion portion 632-2. For example, the first protrusion portion 632-1 may have a cylindrical shape 1150, and the second protrusion portion 632-2 may have a triangular prism shape. The cylindrical shape 1150 of the first protrusion 632-1 of the example 1105 may be a structure to facilitate assembly between the supporting member 530 and the groove (e.g., the groove 525 of FIG. 5A) of the second housing part (e.g., the second housing part 132a). As a non-limiting example, when a shape of the second protrusion portion 632-2 of the example 1105 is formed in a cylindrical shape instead of a triangular prism shape, the assembly between the supporting member 530 and the groove may be easier.

Referring to the example 1106, the supporting member 530 may include the base portion 531 and the protrusion portion 532. As a non-limiting example, the protrusion portion 532 may include the first protrusion portion 632-1, the second protrusion portion 632-2, and a third protrusion portion 1160. The first protrusion portion 632-1 may have a cylindrical shape, the second protrusion portion 632-2 may have a cylindrical shape, and the third protrusion portion 1160 may have a cylindrical shape. For example, the third protrusion portion 1160 may be formed on the region 633 of the example 1101 (or the example 1102). The supporting member 530 of the example 1106 may have a structure capable of performing more stable distribution of force by including the distributed protrusion portions 632-1, 632-2, and 1160.

FIG. 11 illustrates examples of various shapes of the supporting member 530 of FIG. 6A, but the present disclosure is not limited thereto. For example, the various shapes of FIG. 11 may be applied in substantially the same way to the supporting member 530 that includes at least one hole for a screw, such as the supporting member 530 of FIG. 8.

FIG. 12 is a block diagram illustrating an example electronic device 1201 in a network environment 1200 according to various embodiments.

Referring to FIG. 12, the electronic device 1201 in the network environment 1200 may communicate with an electronic device 1202 via a first network 1298 (e.g., a short-range wireless communication network), or at least one of an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220, memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module (SIM) 1296, or an antenna module 1297. In various embodiments, at least one of the components (e.g., the connecting terminal 1278) may be omitted from the electronic device 1201, or one or more other components may be added in the electronic device 1201. In various embodiments, some of the components (e.g., the sensor module 1276, the camera module 1280, or the antenna module 1297) may be implemented as a single component (e.g., the display module 1260).

The processor 1220 may execute, for example, software (e.g., a program 1240) to control at least one other component (e.g., a hardware or software component) of the electronic device 1201 coupled with the processor 1220, and may perform various data processing or computation. According to an embodiment, as at least part of the data processing or computation, the processor 1220 may store a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), or an auxiliary processor 1223 (e.g., a graphics processing unit (GPU), a neural processing unit (NPU), an image signal processor (ISP), a sensor hub processor, or a communication processor (CP)) that is operable independently from, or in conjunction with, the main processor 1221. For example, when the electronic device 1201 includes the main processor 1221 and the auxiliary processor 1223, the auxiliary processor 1223 may be adapted to consume less power than the main processor 1221, or to be specific to a specified function. The auxiliary processor 1223 may be implemented as separate from, or as part of the main processor 1221. Thus, the processor 1220 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1223 may control at least some of functions or states related to at least one component (e.g., the display module 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223. According to an embodiment, the auxiliary processor 1223 (e.g., the neural processing unit) may include a hardware structure specified for artificial intelligence model processing. An artificial intelligence model may be generated by machine learning. Such learning may be performed, e.g., by the electronic device 1201 where the artificial intelligence is performed or via a separate server (e.g., the server 1208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input module 1250 may receive a command or data to be used by another component (e.g., the processor 1220) of the electronic device 1201, from the outside (e.g., a user) of the electronic device 1201. The input module 1250 may include, for example, a microphone, a mouse, a keyboard, a key (e.g., a button), or a digital pen (e.g., a stylus pen).

The sound output module 1255 may output sound signals to the outside of the electronic device 1201. The sound output module 1255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1260 may visually provide information to the outside (e.g., a user) of the electronic device 1201. The display module 1260 may include, for example, a display, a hologram device, or a projector and control circuitry to control a corresponding one of the display, hologram device, and projector. According to an embodiment, the display module 1260 may include a touch sensor adapted to detect a touch, or a pressure sensor adapted to measure the intensity of force incurred by the touch.

The audio module 1270 may convert a sound into an electrical signal and vice versa. According to an embodiment, the audio module 1270 may obtain the sound via the input module 1250, or output the sound via the sound output module 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, an HDMI connector, a USB connector, an SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to an embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The wireless communication module 1292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., the mmWave band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20 Gbps or more) for implementing eMBB, loss coverage (e.g., 1264 dB or less) for implementing mMTC, or U-plane latency (e.g., 0.5 ms or less for each of downlink (DL) and uplink (UL), or a round trip of 12 ms or less) for implementing URLLC.

The antenna module 1297 may transmit or receive a signal or power to or from the outside (e.g., the external electronic device) of the electronic device 1201. According to an embodiment, the antenna module 1297 may include an antenna including a radiating element include a conductive material or a conductive pattern formed in or on a substrate (e.g., a printed circuit board (PCB)). According to an embodiment, the antenna module 1297 may include a plurality of antennas (e.g., array antennas). In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

According to various embodiments, the antenna module 1297 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 or 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, mobile edge computing (MEC), or client-server computing technology may be used, for example. The electronic device 1201 may provide ultra low-latency services using, e.g., distributed computing or mobile edge computing. In an embodiment, the external electronic device 1204 may include an internet-of-things (IoT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology.

The technical problems addressed in the present disclosure are not limited to those described above, and any other technical problems not mentioned herein will be clearly understood by those having ordinary knowledge in the art to which the present disclosure belongs.

As described above, a head-wearable electronic device 100 may comprise an enclosure 110. The enclosure 110 may include at least one display 180 disposed in front of eyes of a user when the head-wearable electronic device 100 is worn. The enclosure 110 may include a frame 111 supporting the at least one display 180. The head-wearable electronic device 100 may comprise a rear cover 120 supporting a head of the user wearing the head-wearable electronic device 100. The head-wearable electronic device 100 may comprise a side band 130 connecting the enclosure 110 to the rear cover 120. The side band 130 may include a housing 130a defining an exterior of the side band 130 and including a portion connected to an inner portion of the frame 111. The side band 130 may include a supporting member 530. The portion of the housing 130a of the side band 130 may define a groove 525 (e.g., a first groove). The supporting member 530 may include a base portion 531 contacting with the frame 111 of the enclosure 110 and the portion of the housing 130a of the side band 130. The supporting member 530 may include a protrusion portion 532 (e.g., a first protrusion portion), extending from the base portion 531 of the side band 130 to the groove 525, disposed at the groove 525.

According to an embodiment, the protrusion portion 532 of the side band 130 may be attached to the groove 525 through an adhesive member.

According to an embodiment, the portion of the housing 130a of the side band 130 may further define another groove 525 (e.g., a second groove) spaced apart from the groove 525. The supporting member 530 may further include another protrusion portion 532 (e.g., a second protrusion) extending from the base portion 531 of the side band 130 to the other groove 525, disposed at the other groove 525. The other protrusion portion 532 of the side band 130 may be attached to the other groove 525 through an adhesive member.

According to an embodiment, the frame 111 of the enclosure 110 may further include a convex portion 540 extending from the inner portion of the frame 111. The base portion 531 may further include a concave portion 640 aligned with the convex portion 540. The concave portion 640 of the base portion 531 may fit in the convex portion 540 of the frame 111.

According to an embodiment, the concave portion 640 of the base portion 531 may be positioned between the protrusion portion 532 and the other protrusion portion 532.

According to an embodiment, the base portion 531 of the supporting member 530 may include a first portion 531-1 disposed peripherally to the protrusion portion 532. The base portion 531 of the supporting member 530 may include a second portion 531-2 extending from the first portion 531-1 and substantially perpendicular to the first portion 531-1.

According to an embodiment, the first portion 531-1 of the base portion 531 may be contacted with the portion of the housing 130a of the side band 130. The second portion 531-2 of the base portion 531 may be contacted with the inner portion of the enclosure 110.

According to an embodiment, the frame 111 may define an opening 419. The portion of the housing 130a of the side band 130 may be contacted with the inner portion of the frame 111 through the opening 419. The portion of the housing 130a of the side band 130 may be coupled with the inner portion of the frame 111 through a screw 490.

According to an embodiment, the housing 130a of the side band 130 may include a first housing part 131a configured to be contacted with the head of the user wearing the head-wearable electronic device 100 and defining a first hole 510 in the portion. The housing 130a of the side band 130 may include a second housing part 132a opposite to the first housing part 131a, defining a second hole 520 aligned with the first hole 510 and the groove 525 in the portion. The screw 490 may couple the first housing part 131a, the second housing part 132a, and the frame 111 through the first hole 510 and the second hole 520.

According to an embodiment, the frame 111 may include a third hole 730 aligned with each of the first hole 510 and the second hole 520 in the inner portion. The screw 490 may couple the first housing part 131a, the second housing part 132a, and the frame 111 by extending from the second housing part 132a to the third hole 730 of the frame 111 through the first hole 510 and the second hole 520.

According to an embodiment, the groove 525 of the second housing part 132a may be spaced apart from the second hole 520 of the second housing part 132a.

According to an embodiment, the first housing part 131a may be coupled with the second housing part 132a through an adhesive material.

According to an embodiment, the first housing part 131a may include loops 320. The second housing part 132a may include hooks 350 corresponding to the loops 320. The first housing part 131a may be coupled with the second housing part 132a by coupling the hooks 350 with the loops 320.

According to an embodiment, the first housing part 131a may be coupled with the second housing part 132a through another screw.

According to an embodiment, the base portion 531 of the supporting member 530 may further include a fourth hole 810 aligned with each of the first hole 510, the second hole 520, and the third hole 730. The screw 490 may couple the supporting member 530, the first housing part 131a, the second housing part 132a, and the frame 111 by extending from the fourth hole 810 of the base portion 531 to the third hole 730 of the frame 111 through the first hole 510, the second hole 520, and the third hole 730.

According to an embodiment, the base portion 531 of the supporting member 530 may further include a fifth hole 820. The frame 111 may further include a sixth hole aligned with the fifth hole 820 in the inner portion. Another screw 890 may couple the supporting member 530 and the frame 111 by extending from the fifth hole 820 of the base portion 531 to the sixth hole of the frame 111 through the fifth hole 820 and the sixth hole.

According to an embodiment, the first housing part 131a may further include a convex portion 910 spaced apart from the first hole 510 in the portion. The second housing part 132a may further include a concave portion 920 spaced apart from the second hole 520 in the portion and aligned with the convex portion 910 of the first housing part 131a. The concave portion 920 of the second housing part 132a may fit in the convex portion 910 of the first housing part 131a.

According to an embodiment, the inner portion of the frame 111 may further include a concave portion 1020. The first housing part 131a may further include a convex portion 1010 aligned with the concave portion 1020 of the inner portion of the frame 111. The concave portion 1020 of the inner portion of the frame 111 may fit in the convex portion 1010 of the first housing part 131a.

According to an embodiment, the enclosure 110 of the head-wearable electronic device 100 may further include an electronic component disposed within the enclosure 110. The electronic component may be disposed on the supporting member 530.

According to an embodiment, the side band 130 may include at least one of a speaker 151a or 151b or an interface 155 for charging of the head-wearable electronic device 100.

The effects that may be obtained from the present disclosure are not limited to those described above, and any other effects not mentioned herein will be clearly understood by those having ordinary knowledge in the art to which the present disclosure belongs, from the following description.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1240) including one or more instructions that are stored in a storage medium (e.g., internal memory 1236 or external memory 1238) that is readable by a machine (e.g., the electronic device 1201). For example, a processor (e.g., the processor 1220) of the machine (e.g., the electronic device 1201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A head-wearable electronic device comprising:
an enclosure including:
at least one display configured to be disposed in front of eyes of a user when the head-wearable electronic device is worn, and
a frame supporting the at least one display;
a rear cover supported by a head of the user wearing the head-wearable electronic device; and
a side band connecting the enclosure to the rear cover;
wherein the side band includes:
a housing, defining an exterior of the side band, including a portion connected to an inner portion of the frame, and
a supporting member, comprising a support,
wherein the portion of the housing of the side band includes a groove, and
wherein the supporting member includes:
a base portion configured to contact the frame of the enclosure and the portion of the housing of the side band, and
a protrusion, extending from the base portion of the side band to the groove, and disposed at the groove.

2. The head-wearable electronic device of claim 1,
wherein the protrusion of the side band is attached to the groove through an adhesive member comprising an adhesive.

3. The head-wearable electronic device of claim 1,
wherein the portion of the housing of the side band further includes another groove spaced apart from the groove,
wherein the supporting member further includes another protrusion, extending from the base portion of the side band to the another groove, disposed at the another groove, and
wherein the another protrusion of the side band is attached to the another groove by an adhesive member comprising an adhesive.

4. The head-wearable electronic device of claim 3,
wherein the frame of the enclosure further includes a convex portion extending from the inner portion of the frame,
wherein the base portion further includes a concave portion aligned with the convex portion, and
wherein the concave portion of the base portion is configured to fit in the convex portion of the frame.

5. The head-wearable electronic device of claim 4,
wherein the concave portion of the base portion is positioned between the protrusion and the another protrusion.

6. The head-wearable electronic device of claim 1,
wherein the base portion of the supporting member includes:
a first portion disposed peripherally to the protrusion, and
a second portion, extending from the first portion, substantially perpendicular to the first portion.

7. The head-wearable electronic device of claim 6,
wherein the first portion of the base portion is configured to contact the portion of the housing of the side band, and
wherein the second portion of the base portion is configured to contact the inner portion of the enclosure.

8. The head-wearable electronic device of claim 1,
wherein the frame includes an opening,
wherein the portion of the housing of the side band is configured to contact the inner portion of the frame through the opening, and
wherein the portion of the housing of the side band is coupled with the inner portion of the frame via a screw.

9. The head-wearable electronic device of claim 8,
wherein the housing of the side band includes:
a first housing part, configured to contact the head of the user wearing the head-wearable electronic device, and including a first hole in the portion, and
a second housing part, opposite to the first housing part, including a second hole aligned with the first hole and the groove in the portion,
wherein the screw is configured to couple the first housing part, the second housing part, and the frame via the first hole and the second hole.

10. The head-wearable electronic device of claim 9,
wherein the frame includes a third hole aligned with each of the first hole and the second hole in the inner portion, and
wherein the screw is configured to couple the first housing part, the second housing part, and the frame by extending from the second housing part to the third hole of the frame through the first hole and the second hole.

11. The head-wearable electronic device of claim 9,
wherein the groove of the second housing part is spaced apart from the second hole of the second housing part.

12. The head-wearable electronic device of claim 9,
wherein the first housing part is coupled to the second housing part through an adhesive material.

13. The head-wearable electronic device of claim 9,
wherein the first housing part includes loops,
wherein the second housing part includes hooks corresponding to the loops, and
wherein the first housing part is configured to be coupled to the second housing part by coupling of the hooks with the loops.

14. The head-wearable electronic device of claim 9,
wherein the first housing part is configured to be coupled with the second housing part through another screw.

15. The head-wearable electronic device of claim 10,
wherein the base portion of the supporting member further includes a fourth hole aligned with each of the first hole, the second hole, and the third hole, and
wherein the screw is configured to couple the supporting member, the first housing part, the second housing part, and the frame by extending from the fourth hole of the base portion to the third hole of the frame through the first hole, the second hole, and the third hole.

16. The head-wearable electronic device of claim 15,
wherein the base portion of the supporting member further includes a fifth hole,
wherein the frame further includes a sixth hole aligned with the fifth hole in the inner portion, and
wherein another screw is configured to couple the supporting member and the frame by extending from the fifth hole of the base portion to the sixth hole of the frame through the fifth hole and the sixth hole.

17. The head-wearable electronic device of claim 9,
wherein the first housing part further includes a convex portion spaced apart from the first hole in the portion,
wherein the second housing part further includes a concave portion, spaced apart from the second hole in the portion, aligned with the convex portion of the first housing part, and
wherein the concave portion of the second housing part is configured to fit in the convex portion of the first housing part.

18. The head-wearable electronic device of claim 9,
wherein the inner portion of the frame further includes a concave portion,
wherein the first housing part further includes a convex portion aligned with the concave portion of the inner portion of the frame, and
wherein the concave portion of the inner portion of the frame is configured to fit in the convex portion of the first housing part.

19. The head-wearable electronic device of claim 1,
wherein the enclosure of the head-wearable electronic device further includes an electronic component comprising circuitry disposed within the enclosure, and
wherein the electronic component is disposed on the supporting member.

20. The head-wearable electronic device of claim 1,
wherein the side band includes at least one of a speaker or an interface configured to charge the head-wearable electronic device.
